(19) United States
(12) Patent Application Publication
(10) Pub. No.: US 2021/0046782 A1
(43) Pub. Date: Feb. 18, 2021

(54) A METHOD OF MANUFACTURING DECORATIVE PANELS

(71) Applicant: Agfa NV, Mortsel (BE)

(72) Inventor: Pascal Meeus, Mortsel (BE)

(21) Appl. No.: 16/978,752

(22) PCT Filed: Feb. 25, 2019
(86) PCT No.: PCT/EP2019/054554

§ 371 Date: Sep. 7, 2020

(30) Foreign Application Priority Data
Mar. 9, 2018 (EP) 18160937.1

(51) Int. Cl. B44C 5/04; B41M 5/00; B41M 7/00

(52) U.S. Cl. CPC B44C 5/04; B41M 5/0047; B41M 7/0027; B41M 5/0064; B41M 7/009

(57) ABSTRACT

A method of manufacturing decorative panels and a system for manufacturing decorative panels including the steps of inkjet printing a first decorative layer (301) in a web-fed inkjet print system in a first time period; and inkjet printing a second decorative layer (302) in the web-fed inkjet print system in a second time period; and heat pressing the first decorative layer (301) into a decorative panel (331) on a first heat press (401); and heat pressing the second decorative layer (302) into another decorative panel (332) on a second heat press (402); and wherein the first and second time period overlap.

### TECHNICAL FIELD

The present invention is related to the manufacturing of decorative panels wherein the decorative image, such as a wood pattern, is printed by a web-fed inkjet print system on a substrate to become a decorative layer which is than heat pressed together with one or more other layers to a decorative panel by using a thermosetting resin; which may be cut into a plurality of decorative laminates. Such decorative panels and decorative laminates are mainly used as decorative flooring, decorative wall elements and used in decorative furniture.

### BACKGROUND ART

Gravure, offset and flexography are being increasingly replaced for different applications by industrial inkjet printing systems, which have now proven their flexibility in use, such as variable data printing, making short production runs and personalized products possible, and their enhanced reliability, allowing incorporation into production lines.

Inkjet technology has also been implemented by manufacturers of decorative panels, such as laminate floor. A historical overview and dedicated case studies of a web-fed inkjet print system for printing decorative images on deco-paper to manufacture decorative panels, are disclosed in Chapter 44 “Industrial Inkjet Printing in Decorative Web Print Applications” by Patnk Lutz and Chapter 48 “Hymmen Digital Décor Printing: Empowering the Laminate Industry by Aliasgar Eranpurwala in ” Handbook of Industrial Inkjet Printing: A Full System Approach”, edited by Werner Zapka (publisher Wiley-VCH Verlag GmbH & Co, 22/11/2017, 984 pages).

Also multi pass inkjet printers are used as web-fed inkjet print system for the manufacturing of decorative panels. This is for example disclosed in the following published European patent application EP2905145 A1 (UNILIN BVBA) wherein in paragraph [0024] a multi pass inkjet system is disclosed for the manufacturing of decorative panels.

Some decorative panels have to be manufactured by a specific configuration of heat press (e.g. size, embossing plate, heat temperature, adding of an extra layer such as a protective layer) and other decorative panels have to be manufactured by another specific configuration of a heat press. To avoid switching between configurations, more than one heat press are available in the manufacturing line of decorative panels.

To avoid that the decorative layers, comprising an inkjet printed decorative pattern, are wrongly manufactured by an incorrect configuration of a heat press, there is need for a solution that such waste is avoided and that down-time due to such wrong allocation of a heat press is shunned. Similar there is need for a solution to avoid that such decorative layers are assigned to incompatible heat press e.g. due to the size of the decorative layers.

A solution is that more than one web-fed inkjet print system is available in the manufacturing line of decorative panels. However, this is an uneconomical solution. For example, a Hymmen™ Jupiter JPT-W printing with CMYK inkjet inks contains more than 200 inkjet printheads to cover a width of 2.20 m, which makes it a very costly machine. Also than there is extra need of room space, a larger energy cost, more need for extra suction power of exhaust gasses, the need of an operator per web-fed inkjet print system.

With the new possibility of personalizing decorative panels, very short-runs are expected wherein such a solution is more needed than ever. Such heat presses could be located remotely from the web-fed inkjet print system thus wrong allocation to such a heat press should be avoided to limit the manufacturing time of the decorative panels, especially the personalized decorative panels e.g. decorative panels with printed company names and logos such decorative-panels-on-demand, which are orders of singular or small quantities of decorative panels needs a fast and smooth production flow.

### SUMMARY OF INVENTION

It has been found that the problem described above can be overcome by using a web-fed inkjet print system for inkjet printing a first decorative layer and second decorative layer in an overlapping period and allocate the first decorative layer to a first heat press and the second decorative layer to a second heat press. By printing the first and second decorative layer in an overlapping period (e.g. simultaneously or partly simultaneously) the manufacturing time of decorative panels (331, 332) can be shortened and this by only one web-fed inkjet print system which is economical beneficial.

Preferred embodiments of the present invention have been realised with a decorative panel manufacturing method as defined by claim 1. Preferred embodiment of the present invention have been realised by a manufacturing line for decorative panels as defined by claim 9.

### BRIEF DESCRIPTION OF DRAWINGS

FIG. 1 illustrates a part of a manufacturing line for decorative panels as preferred embodiment of the present invention. The part is related to the inkjet printing of the first decorative layer (301) and second decorative layer (302) as in the present invention. The web-fed inkjet print system is illustrated as a side view (I) and corresponding cross section (II). The web-fed inkjet system is part of a manufacturing line, which is not fully illustrated, comprises a first web substrate on a first unwind roll (101) and a second web substrate on a second unwind roll (102). The second unwind roll (102) is not visible on the side-view of the web-fed inkjet system. Both unwind rolls are attached on a shaft (95) which rotates while transporting both web substrates underneath an inkjet printhead unit (500). By jetting ink droplets (505) on the first and second web substrate, a decorative image is formed on the first web substrate and another decorative image is formed on the second web substrate. Both decorative images are printed in an overlapped period. The first web substrate and second web substrate are supported by a print table (200) while transporting and printing. The first decorative layer (301) is wounded on a first wind roll (701) and the second decorative layer (302) is wounded on a second wind roll (702). Both wind rolls are rotatable attached on a separate shaft (95). The arced arrows illustrates the rotation direction of the rolls.

FIG. 2 illustrates a part of a manufacturing line for decorative panels as preferred embodiment of the present invention. The part is related to the inkjet printing of the first decorative layer (301) and second decorative layer (302) as in the present invention. The web-fed inkjet print system is illustrated as a side view (I) and corresponding cross section (II). The web-fed inkjet system is part of a manufacturing line, which is not fully illustrated, comprises a web substrate on an unwind roll (101). The unwind roll is attached on a shaft (95) which rotates while transporting the web substrate underneath an inkjet printhead unit (500). By jetting ink droplets (505) and the second web substrate, a decorative image is formed on the web substrate and another decorative image is formed on the web substrate. Both decorative images are printed in an overlapped period. The web substrate is supported by a print table (200) while transporting and printing. The web substrate is slitted by a slitter (600, symbol of a scissor) alongside the web substrate to have a first web substrate forming a first decorative layer (301) and a second web substrate forming a second decorative layer (302). The first decorative layer (301) is wounded on a first wind roll (701) and the second decorative layer (302) is wounded on a second wind roll (702). Both wind rolls are rotatable attached on a separate shaft (95). The arced arrows illustrate the rotation direction of the rolls.

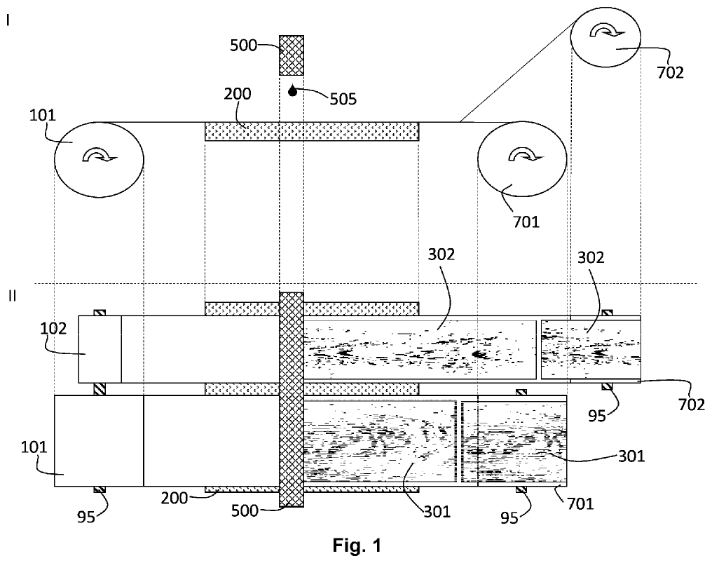

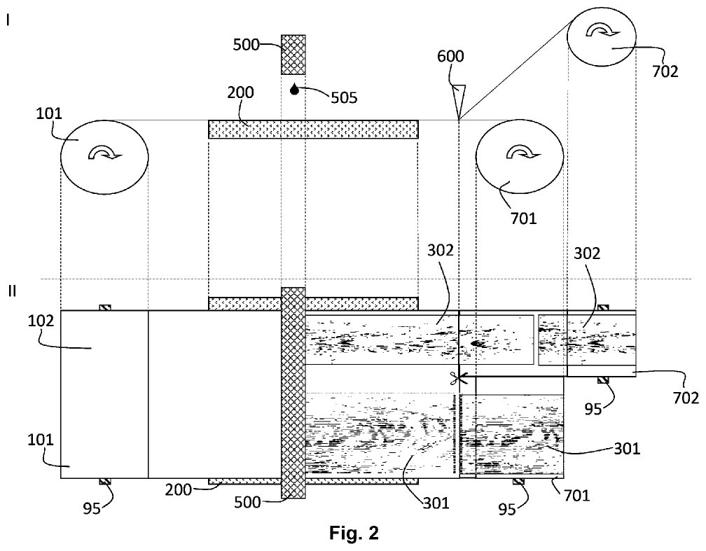

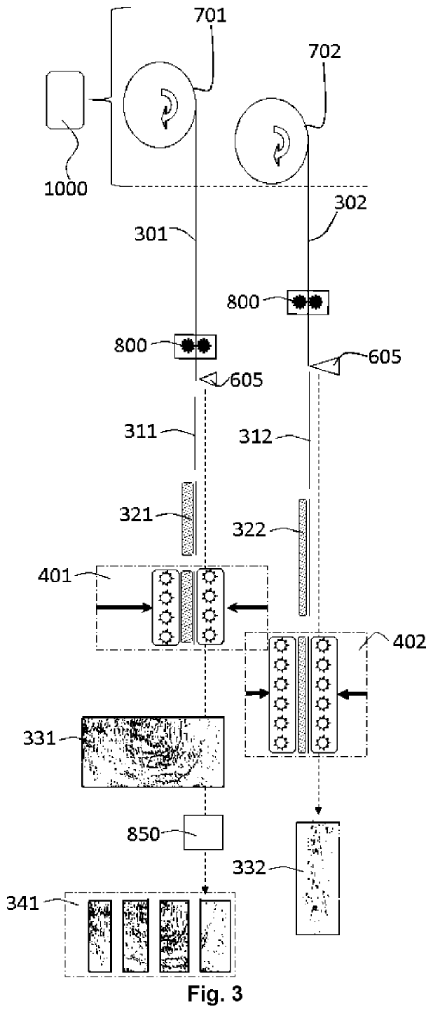

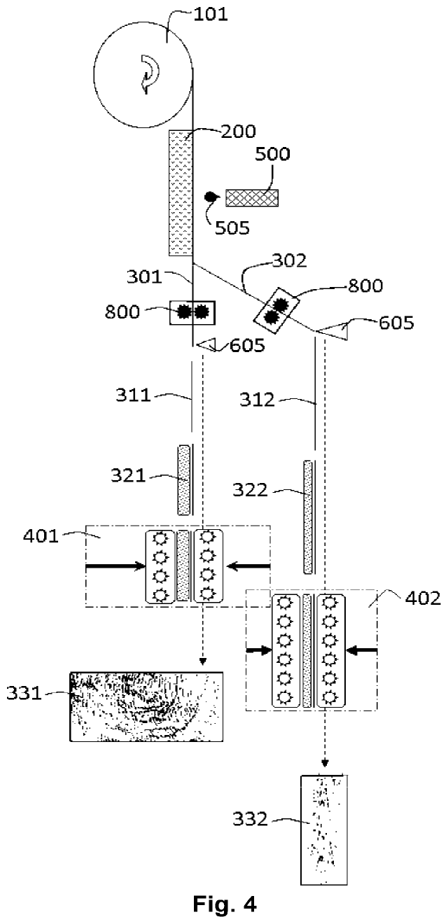

FIG. 3 illustrates a part of a manufacturing line which follows on the illustrated parts of the manufacturing lines in FIG. 1 or FIG. 2 (1000). The first wind roll (701), comprising the first decorative layer (301), is
(a1) unwounded;
(b1) resin-impregnated by a resin impregnator (800);
(c1) cut to a first sheet-shaped resin impregnated decorative layer (311) by a sheet cutter (605);
(d1) a core layer (321) is supplied to the first sheet-shaped resin impregnated decorative layer;
(e1) heat-pressed by a first heat press (401);
(f1) after the heat pressing a decorative panel (331) is formed comprising the first decorative layer (301):
(g1) a panel cutter (850) cuts the decorative panel (311) in a plurality of decorative laminates (341).
The second wind roll (702), comprising the second decorative layer (302), is (a2) unwounded;
(b2) resin impregnated by another resin impregnator (800);
(c2) cut to a second sheet-shaped resin impregnated decorative layer (312) by a sheet cutter (605);
(d2) a core layer (322) is supplied to the second sheet-shaped resin impregnated decorative layer;
(e2) heat-pressed by a second heat press (402);
(f2) after the heat pressing a decorative panel (332) is formed comprising the second decorative layer (302):
The dashed arrow illustrates the several steps in the manufacturing line from (a1) to (g1) or from (a2) to (f2). The first heating press (401) has a certain dimension and the length of the thick arrows is indication on the pressure while heat pressing, while the second heating press (402) has another dimension because the second decorative layer (302) had another width/length than the first decorative layer (301) and a lower pressure while heat pressing. The arced arrows illustrate the rotation direction of the rolls.

FIG. 4 is a preferred embodiment whereby no wind rolls (701, 702) are used as in FIG. 1, FIG. 2 and FIG. 3. FIG. 4 illustrates a part of a manufacturing line for decorative panels as preferred embodiment of the present invention. The part comprises the inkjet printing of the first decorative layer (301) and second decorative layer (302) as in the present invention. The web-fed inkjet print system is illustrated only as a side view (I). A cross section is derivable from the previous figures and thus not shown. The web-fed inkjet system is part of a manufacturing line, which is not fully illustrated, comprises a first web substrate on a first unwind roll (101) and a second web substrate on a second unwind roll (102). The second unwind roll (102) is not visible on the side-view of the web-fed inkjet system. Both unwind rolls are attached on a shaft (95) which rotates while transporting both web substrates underneath an inkjet printhead unit (500). By jetting ink droplets (505) on the first and second web substrate, a decorative image is formed on the first web substrate and another decorative image is formed on the second web substrate. Both decorative images are printed in an overlapped period. The first web substrate and second web substrate are supported by a print table (200) while transporting and printing. The first web substrate, comprising the first decorative layer is:
(b1) resin impregnated by a resin impregnator (800);
(c1) cut to a first sheet-shaped resin impregnated decorative layer (311) by a sheet cutter (605);
(d1) a core layer (321) is supplied to the first sheet-shaped resin impregnated decorative layer;
(e1) heat-pressed by a first heat press (401);
(f1) after the heat pressing a decorative panel (331) is formed comprising the first decorative layer (301):
(g1) a panel cutter (850) cuts the decorative panel (311) in a plurality of decorative laminates (341).
The second web substrate, comprising the second decorative layer is
(b2) resin impregnated by another resin impregnator (800);
(c2) cut to a second sheet-shaped resin impregnated decorative layer (312) by a sheet cutter (605);
(d2) a core layer (322) is supplied to the second sheet-shaped resin impregnated decorative layer;
(e2) heat-pressed by a second heat press (402);
(f2) after the heat pressing a decorative panel (332) is formed comprising the second decorative layer (302):
The dashed arrow illustrates the several steps in the manufacturing line from (a1) to (g1) or from (a2) to (f2). The first heating press (401) has a certain dimension and the length of the thick arrows is indication on the pressure while heat pressing, while the second heating press (402) has another dimension because the second decorative layer (302) had another width/length than the first decorative layer (301) and a lower pressure while heat pressing. The arced arrow illustrates the rotation direction of the rolls.

### DESCRIPTION OF EMBODIMENTS

The present invention comprises the following embodiment:

A method of manufacturing decorative panels (331, 332) including the steps of:
inkjet printing a first decorative layer (301) in a web-fed inkjet print system in a first time period; and
inkjet printing a second decorative layer (302) in the web-fed inkjet print system in a second time period; and
heat pressing the first decorative layer (301) into a decorative panel (331) on a first heat press (401); and
heat pressing the second decorative layer (302) into another decorative panel (332) on a second heat press (402); and

wherein the first and second time period overlap.

The web-fed inkjet print system can be operated by only one person in each shift. It is also found that there is less waste of unprinted web substrate whereon the decorative image is printed to form the first and/or second decorative layer (302) by using the method of the present invention. The substrate of the first decorative layer (301) and the substrate of the second decorative layer (302) can be different for example: the first decorative layer (301) for high end decorative panels and the second decorative layer (302) for low end decorative panels wherein for example cheaper web substrate or a web substrate with a less thicker primer is used. If there is less demand still the web-fed inkjet print system can be used by inkjet printing only one decorative layer in a certain period with less requests. The invention makes the web-fed inkjet print system multi-employable and easy integrable, causing the manufacturing method of the present invention to become versatile in its usage. It may be adapted to many different methods of manufacturing decorative panels (331, 332) and adapted to many different dimensions of decorative panels (331, 332). More than 2 decorative layers, respectively more than 2 heat presses are hereby also presented.

The inkjet printing of the first and second decorative layer (302) is performed by the web-fed inkjet print system. The web-fed inkjet print system jets in this printing method droplets of ink from an inkjet printhead on a web substrate whereby the jetted ink forms a decorative image. The decorative image is preferably a decorative pattern, such as wood pattern, stone pattern or phantasy repetitive pattern but most preferably a wood pattern (e.g. hardwood pattern, oak wood pattern, teak wood pattern). A decorative image is preferably an oligochromatic image, an image with a few (=oligo, \dot{o}λíγyol) colors (chromatic). Thus not a monochromatic image, which is an image with one (=mono) color and thus also not a polychromatic image, which is an image with a plurality of colors such as a photographic image with content of nature scenery. The decorative layer may comprise multiple copies of the same decorative image and/or one or more copies of minimum two decorative images. These copies are preferably arranged according to a template, also called a lay-out or arranged by a nesting method, as disclosed in WO 2015/117944 (AGFA GRAPHICS NV, UNILIN BVBA). Typically the one or more decorative images, whether or not equal decorative images, for printing a decorative layer, are stored in a print job whereby for example the number of copies, the memory allocation of the decorative image(s) are stored.

Web-fed refers to the use of rolls (or “webs”) of substrate supplied to the printing press. The substrate, also called a web substrate, once inkjet printed with a decorative image, becomes a decorative layer (301, 302) that may be heat pressed by a heat press with other layers (e.g. core layer (321, 322); protective layer, balancing layer) to form a decorative panel. The pressing is preferably done by a pressure up to 25 bars or up to 100 N/cm² and the temperature preferable is up to 200° C. The heat press is for example a short-cycle press such as manufactured by Wemhoener™ Surface Technologies GmbH & Co. KG (http://www.wemhoener.de/en/systems/short-cycle-press-lines) or a double belt press such as MFC Double Belt Press of Hymmen™.

The first and/or second decorative layer (301, 302) may be cutted in one or more sheets, known as a roll-to-sheet-method before supplying the one or more sheets to a heat press or more preferably may be rolled up again as output-roll, known as a roll-to-roll-method before supplying the output-roll to a heat press where it is unrolled (FIG. 3). The one or more sheets or the output-roll may be supplied respectively to the first heat press (401) and second heat press (402). Most preferably, the first and/or decorative layer may also be supplied, whether or not first cut in sheets, directly from the web-fed inkjet print system respectively to the first heat press (401) and the second heat press (402).

The first/second heat press (401, 402) may be located differently than or remotely from: the web-fed inkjet print system and/or the second/first heat press (401, 402). Remotely located means that the first heat press (401) is located on another address, such as street further on, another city or even another country.

In a preferred embodiment is the web-fed inkjet print system a web-fed multi pass inkjet print system which means that a decorative image, comprised on the first/second decorative layer (301, 302) is printed by multiple passes from one or more inkjet printheads over the substrate while printing, preferably by three or four passes and most preferably by two passes. The state-of-the-art single pass inkjet print systems still suffer from major and minor operation failures. A major operation failure is when the single pass inkjet print system is incapable of printing by a technical dysfunction and the manufacturing line of the decorative panels (331, 332) has to be stopped. A minor operation failure is when some of the nozzles from an inkjet printhead are failing to jet ink, thereby creating line artefacts in the printed image and leading to waste of material by a cumbersome removal of these defective decorative panels (331, 332) after heat pressing. Another issue is that, although inkjet printing has the potential of unlimited variable printing, problems of data streaming to the single pass inkjet print system occurred. The variable images to print required such a high computing power that limitations in the variability of the images had to be implemented.

Reasons that some decorative layers have to be heat pressed by a heat press and not by another heat press may come from the difference in configuration between both heat presses e.g. dimension of the heat press, maximum size of layers that can be heat pressed in the heat press, comprising an embossing plate with specific relief in the heat press, minimum/maximum heat temperature of the heat press, adding of an extra layer such as a protective layer at the heat press, the location of the heat press.

The allocation of the correct heat press for a decorative layer may depend on content of the decorative image and/or its meta-data, comprising for example size of decorative image, type of relief structure or even the address of the requester for the manufacturing of the decorative panel. For example a dark decorative image is jetted with a large amount of ink which may cause delamination after heat pressing at a certain temperature (<t₀). If the first heat press (401) is not capable of producing such heat temperature while heat pressing but the second heat press (402) has extra heat power to achieve higher temperature (larger than t₀) while heat pressing than the second heat press (402) is best allocated for decorative layers comprising the dark decorative image to avoid the delamination afterwards in the manufacturing of the decorative panel. Another example is that a small elongated decorative image is assigned to the heat pressing which is capable to heat press small elongate decorative layer comprising this kind of decorative images. If a too large heat press is assigned too much heat-energy may be spoiled and this should be avoided for economically and ecologically reasons.

In a preferred embodiment is the web-fed inkjet print system a dual web printer which comprises a first web substrate for inkjet printing the first decorative layer (301) and a second web substrate for inkjet printing a second decorative layer (302) (FIG. 1, FIG. 4). This preferred web-fed inkjet print system uses a first roll for the inkjet printing the first decorative layer (301) by supplying a first substrate from the first roll and a second roll for inkjet printing the second decorative layer (302) by supplying a second substrate from the second roll.

In another preferred embodiment the web-fed inkjet print system slits a web substrate after inkjet printing into a first web substrate including the first decorative layer (301) and a second web substrate including the second decorative layer (302) (FIG. 2). The slitting is performed by a slitter. Such a slitter comprises a razor blade or circular blade. The advantage is that such slitter may be placed according the width of the decorative layer. The width of a decorative layer or a web substrate in such web-fed inkjet print system is measured along the direction perpendicular to the transport direction of the web substrate and decorative layer. The web substrate may be cut, also called slit, in a plurality of smaller web substrates variable in width. Each cutted smaller web substrate may be supplied to another heat press which is capable of processing (=heat-pressing) the smaller web substrate according the dimensions (width and length) of the decorative layer. For example in flooring, not only floor elements are used, but also very small plinths wereby small elongated decorative layers are printed as intermediate product in the manufacturing process. Depending on the web substrate also a laser based slicing system may be used.

The present invention comprises also an embodiment of a web-fed inkjet print system for manufacturing decorative panels including:
a plurality of printheads for inkjet printing aqueous pigmented inkjet inks and/or pigmented free radical curable inks; and
a first and a second web substrate having on their surface one or more ink-receiving layers to be inkjet printed by the aqueous pigmented inkjet inks. The first and second web substrate is preferably paper, more preferably paper with a porosity according to Gurley's method (DIN 53120) between 8 and 20 seconds. Previously disclosed preferable embodiments in the present invention related to the web-fed inkjet print system are also preferably embodiments for this web-fed inkjet print system. The web-fed inkjet print system is preferably controlled by a workflow system e.g. for managing print jobs, driving inkjet print-heads, controlling temperature at the print-heads, controlling the drying performance of the web-fed inkjet print system. The plurality of printheads may be comprised in an inkjet print unit. The inkjet inks are preferably part of an inkjet ink set.

The present invention comprises also another embodiment of a workflow system for manufacturing decorative panels and workflow method, performed by the workflow system, for manufacturing decorative panels (331, 332) comprising the step of managing a plurality of print jobs for printing decorative images by a web-fed inkjet print system; wherein the plurality of print jobs comprises:
a first print job comprising a first decorative image and an identification of a first location for heat pressing a print copy of the first decorative image into a first decorative panel on the first location; and
a second print job including a second decorative image and an identification of a second location for heat pressing a print copy of the second decorative image into a second decorative panel on the second location. The first and/or second location is preferably a remote location.

The print copy of the first print job is the first decorative layer (301) of the present invention for the method of manufacturing decorative panels (331, 332). The print copy of the second print job is the second decorative layer (302) of the present invention for the method of manufacturing decorative panels (331, 332).

Before the heat pressing step preferably one or more layers (e.g. core layer (321, 322); protective layer, balancing layer) are added to the decorative layer which are heat pressed together in the heat press to form a decorative panel. Such workflow system is further disclosed and more explained in the chapter “deco workflow system”.

The step of managing comprises preferably the additional steps:
assigning the first print job to a first print zone on the web-fed inkjet print system; and
assigning the second print job to a second print zone on the web-fed inkjet print system; and;
inkjet printing the first print job in the first print zone in a first period and the second print job in the second print job in a second period which overlaps the first period; and more preferably the extra steps:
supplying a print copy from the inkjet-printed first print job to the first location; and a print copy from the inkjet-printed second print job to the second location. Supplying may be comprising the step of transporting or delivering a print copy to a location. The inkjet printing of the first and second print job may be multi pass inkjet printing wherein the web-fed inkjet print system is a web-fed multi pass inkjet print system.

The first print zone preferably doesn't overlap the second print zone, to prevent that both print jobs are not printed on top of each other. The dimensions of the print zones may be adapted according to the dimensions of decorative panels (331, 332) and/or dimensions of the heat presses (401, 402).

Previously disclosed preferable embodiments in the present invention related to the manufacturing of decorative panels (331, 332) are also preferably embodiments for the above mentioned workflow system. The workflow system preferably controls the web-fed inkjet print system more than managing print jobs but also driving inkjet print-heads, controlling temperature at the print-heads, controlling a slitter in the print system e.g. changing position by a driver, controlling the drying performance of the print system.

The dimensions (width and/or length) of the print zone depends on the dimensions from an allocated heat press so the print job is dimensionally correctly inkjet printed for supplying to the allocated heat press. The print zone does not to be a separated support table for the web substrate. A support table may be divided in virtual print zones, one print zone for the first print job and another print zone for the second print job. By managing print jobs for allocation the correct heat presses, for example depending on the meta-data of the print job, the assignment of the print job to a certain print zone can be achieved. The length of the print zone is measured in parallel to the transport direction of the web-substrates. The width of the print zone is measured perpendicular to the transport direction of the web-substrates.

The first and/or second print job may also comprising identification how the decorative panel have to be cut or how the decorative panel have to be embossed, whether or not digital embossed. The print job may also comprises the content of an image which represents the relief for the digital embossing system. WO16050372 (AGFA GRAPHICS NV) discloses a method how to manufacture a digital embossing plate for the manufacturing of decorative panels (331, 332).

The workflow system preferably comprises the calculation step for knowing the availability of web substrate in the web-fed inkjet print system.

### Web-Fed Inkjet Print System

The web-fed inkjet print system comprises means for transporting web substrates whereon, with a plurality of inkjet printheads, a decorative image is printed. The plurality of inkjet printheads are preferably comprised in an inkjet printhead unit (500) and more preferably comprises an inkjet ink set for printing a colored decorative image, which is preferably an oligochromatic image, more preferably a wood pattern.

The web-fed inkjet print system comprise means for transporting more than one web substrates for printing a plurality of decorative layers. The more than one web substrates may be a slitted web substrate after printing, more preferably are unwounded, thus supported, at the input of the web-fed inkjet print system each from a roll of substrate.

A roll comprising a web substrate are mounted on a web supply which implements one or more spindles. The spindles are rotated by distributing torque from the drive shaft by a drive mechanism. The spindles are co-axial spindles used for holding the rolls comprising the web substrates. Spindels are also called shafts (95).

The use of more than one spindles, one for each web substrate is preferred to easily load and unload individually the roll comprising the web substrate. The operator of the web-fed inkjet print system may loading on each spindle one roll at the time. The more than one spindle may be connected to each other by a differential which is known in the automobile sector. Such a differential is a gear train with three shafts that has the property that the rotational speed of one shaft is the average speed of the others or a fixed multiple of that average. The drive mechanism is preferably a motor that turns a driveline inside the spindle. Goldenrod™ Corporation provides such equipment for winding and unwinding substrates on/from roll. Such shaft and roll handling are well-known in the state-of-the-art.

The web-fed inkjet print system preferably comprises drying devices for the drying of inkjet printed decorative image. The drying device, such as radiation curing device or infra-red dryer, depends on the type of ink-set that is used in the web-fed inkjet print system.

The transport of the decorative layers to the first or second heat press (402) may be performed by one or more joining stations and/or one or more transport tables and/or one or more conveyor modules up to the assigned heat press. Before the entrance of the decorative layer, whether or not with other layers such as a core layer (321, 322), the layer may be supplied in a fully automated laying area. After the heat pressing the decorative panel may be supplied to a stacking area.

The web-fed inkjet print system preferably comprises web guide and/or a web substrate spreading device for providing a straight transport underneath the plurality of inkjet print heads. Wobbling, web swimming of the web substrate may give color deviations in the decorative layer due to bad color-on-color registration.

The possibilities of change fast between print jobs and the possibilities to organize the priority between print jobs, makes it possible to use the web-fed inkjet print system of the present invention as a proofer for decorative panels (331, 332), before large production with conventional printing systems (gravure, offset and flexography) is started up. Decorators and decorative image designers have now the possibility to have fast a sample of a new created decorative panel.

The web-fed inkjet print system comprises a print table (200) for supporting the web substrates without crinkles underneath the inkjet print head unit. The print table (200) may be a vacuum table for a better holding of the web substrate while printing in a multi-pass web-fed inkjet print system. The print table (200) may also be a conveyor belt whereby the web substrates are supported and preferably hold down by vacuum. When vacuum power is used for holding down the web substrate than the conveyor belt is also called a vacuum belt. The principles of conveyor belt, vacuum belt, print table (200), vacuum table is known by the skilled person.

### Manufacturing Line for Decorative Panels

The web-fed inkjet print system is preferably part of a manufacturing line for decorative panels (331, 332); whereby the manufacturing line for decorative panels (331, 332) comprises:
a web-fed inkjet print system for manufacturing decorative panels (331, 332) including a plurality of printheads for inkjet printing with an aqueous pigmented inkjet ink set; and a first and a second web substrate having on their surface one or more ink-receiving layers to be inkjet printed by the aqueous pigmented inkjet inks; and
a first resin impregnator (800) for resin-impregnating a first decorative layer (301) comprising the first web substrate and a jetted first decorative image by the plurality of printheads; and a first heat press (401) for heat pressing the first decorative layer (301);
a second resin impregnator (800) for resin-impregnating a second decorative layer (302) comprising the second web substrate and a jetted second decorative image by the plurality of printheads; and a second heat press (402) for heat pressing the second decorative layer (302);

Preferably the one or more ink-receiving layers includes an outermost ink-receiving layer containing no inorganic pigment or containing a smaller content of inorganic pigment than an ink-receiving layer between the web substrate and the outermost ink-receiving layer.

The first resin impregnator (800) preferably uses a resin selected from the group consisting of melamine-formaldehyde based resins, ureum-formaldehyde based resins and phenol-formaldehyde based resins for the impregnation of the first decorative layer (301).

Preferably the ink set include a red inkjet ink containing a pigment selected from the group consisting of C.I. Pigment Red 254, C.I. Pigment Red 176 and C.I. Pigment Red 122 or mixed crystals thereof.

Preferably the first decorative layer (301) is heat pressed into a decorative panel together with a core layer (321, 322) and protective layer; and whereby the core layer (321, 322) is selected from the group of MDF, HDF or OSB.

The present invention comprises also the following embodiment:

A method of manufacturing decorative panels (331, 332) including the steps of:
inkjet printing a first decorative layer (301) in a web-fed inkjet print system in a first time period; and
inkjet printing a second decorative layer (302) in the web-fed inkjet print system in a second time period; and
resin-impregnating the first decorative layer (301) by a first resin impregnator (800); and
heat pressing the second decorative layer (302) by a second resin impregnator (800); and

wherein the first and second time period overlap. The decorative layers (301, 302) hereby comprise preferably a paper substrate as defined below under ‘Paper Substrates for decorative panels’.

The resin is preferably selected from the group consisting of melamine-formaldehyde basis resins, ureum-formaldehyde basis resins and phenol-formaldehyde basis resins. This preferred embodiment has the same inventive concept as the manufacturing met how with the first and second heat-press. It is a solution to the same problem according the manufacturing method with the first and second heat-press.

Analogue the web-fed inkjet print system can be operated by only one person in each shift. It is also found that there is less waste of unprinted web substrate whereon the decorative image is printed to form the first and/or second decorative layer (302) by using the method of the present invention. The substrate of the first decorative layer (301) and the substrate of the second decorative layer (302) can be different for example: the first decorative layer (301) for high end decorative panels and the second decorative layer (302) for low end decorative panels wherein for example cheaper web substrate or a web substrate with a less thicker primer is used. If there is less demand still the web-fed inkjet print system can be used by inkjet printing only one decorative layer in a certain period with less requests. The invention makes the web-fed inkjet print system multi-employable and easy integrable, causing the manufacturing method of the present invention to become versatile in its usage. It may be adapted to many different methods of manufacturing decorative panels (331, 332) and adapted to many different dimensions of decorative panels (331, 332). More than 2 decorative layers, respectively more than 2 resin impregnators are hereby also presented. The thickness of resin while applying it in the resin impregnator (800) may be changed by controlling the resin impregnator (800) for example by applying an impregnation roll with more pressure towards the paper substrate. For example for decorative panels wherein a post-formable step is applied, less resin is used in the impregnation step.

Reasons that some decorative layers have to be impregnated by a resin impregnation and not by another resin impregnator (800) may come from the difference in configuration between both resin impregnators e.g. dimension of the resin impregnator, maximum size of layers that can be impregnated in the resin impregnator, minimum/maximum applicable thickness of the resin impregnator, adding of an extra layer such as another kind of resin, the location of the resin impregnator.

Methods for resin-impregnating a decorative layer with resin are well-known in the art as exemplified by WO 2012/126816 (VITS) and EP 966641 (VITS).

Web-fed refers to the use of rolls (or “webs”) of substrate supplied to the printing press. The substrate, also called a web substrate, once inkjet printed with a decorative image, becomes a decorative layer (301, 302) that in this preferred embodiment is impregnated by a resin impregnator. The method of resin-impregnating, use of a type of resin impregnator or use of a type of resin may be different depending on the type decorative panel, such as less usage of resin while resin-impregnating, fully impregnation of the decorative layer.

The first and/or second decorative layer (301, 302) may be cutin one or more sheets, known as a roll-to-sheet-method before supplying the one or more sheets to a resin impregnator or more preferably may be rolled up again as output-roll, known as a roll-to-roll-method before supplying the output-roll to a heat press where it is unrolled (FIG. 3). The one or more sheets or the output-roll may be supplied respectively to the first resin impregnator and second resin impregnator. Most preferably, the first and/or decorative layer may also be supplied, whether or not first cut in sheets, directly from the web-fed inkjet print system respectively to the first resin impregnator and the second resin impregnator.

The first/second resin impregnator may be located differently than or remotely from: the web-fed inkjet print system and/or the second/first resin impregnator. Remotely located means that the first resin impregnator is located on another address, such as street further on, another city or even another country.

### Decorative Panels (331, 332)

A decorative panel is preferably selected from the group consisting of kitchen panels, flooring panels, furniture panels, ceiling panels and wall panels.

Decorative panels (331, 332) are constructed together for a large planar surface (see http://www.unilin.com/en/flooring), such as floor or wall, or for cupboards or sideboards, which comprises one or more large planar surfaces (see http://www.unilin.com/en/panels).

The manufacturing method from the present invention preferably includes in the first and second decorative layers (301, 302) a paper substrate having on its surface one or more ink-receiving layers inkjet printed by aqueous pigmented inkjet inks. The outermost ink-receiving layer from the one or more ink-receiving layer contains no inorganic pigment or contains a smaller content of inorganic pigment than an ink-receiving layer between the paper substrate and the outermost ink-receiving layer. The outermost ink-receiving layer is the layer that receives first the droplets from the inkjet print head. The paper substrate is preferably impregnated by a thermosetting resin before heat pressing.

A decorative panel may also be a decorative vinyl tile. The manufacturing process of such decorative vinyl tiles is further disclosed. The manufacturing method from the present invention preferably includes in the first and second decorative layers (301, 302) a thermoplastic substrate inkjet printed by UV curable pigmented inkjet inks.

### a) Manufacturing Decorative Panels (331, 332)

The method of manufacturing decorative panels (331, 332) of the present invention is heat pressing the first decorative layer (301) on top of a core layer (321, 322), preferably a wood-based layer. The web substrate that is used for the first and/or second decorative layer (302) may be impregnated before the inkjet printing step by a thermosetting resin or the inkjet printed substrate, thus the respectively the first and second decorative layer (301, 302), may be impregnated by a thermosetting resin before the heat-pressing step by respectively the first and the second heat press (401 and 402).

There are various industrial standards specifically applied for high-pressure decorative panels (331, 332) such as European Standard EN438 (all parts) and International Standard ISO 4586-1.

The thermosetting resin is preferably selected from the group consisting of melamine-formaldehyde based resins, ureum-formaldehyde based resins and phenol-formaldehyde based resins; and the inkjet receiving layer preferably contains an inorganic pigment P and a polymeric binder B; and wherein the pigment P is selected from the group consisting of alumina hydrates, aluminum oxides, aluminum hydroxides, aluminum silicates, and silicas.

In a preferred embodiment of the method for manufacturing decorative panels (331, 332), the decorative panel includes a tongue and a groove capable of achieving a glue less mechanical join between decorative panels (331, 332). Such tongue and groove are mainly applied on the decorative panel by a drilling method by e.g. a milling cutter or a helical wick. The decorative panel may be cut in smaller decorative panels (850, 341). There is great variances in panel formats before cutting in smaller decorative panels. For example Arpa Industriale™ manufactures the following sizes in their production: 2440×1220, 3050×1300, 4200×1300, 4200×1600, 4300×1850, defined in mm's, and where there is also variances in thicknesses between 0.6 and 30 mm. For each size another heat press may be needed.

The cutting in smaller decorative panels, such as decorative laminates a circular saw may be used. A recommended specification for a circular saw is a circular saw with tooth pitch between 10 to 15 mm, cutting speed between 3000 to 4000 rpm with a forward speed between 15 to 30 m/min. The thickness of the blade should not be too thin. If they are less than 2 mm thick, they lose rigidity and then vibrate which makes the cut less precise.

Preferably the manufacturing method is part of a DPL process, wherein the decorative layer is taken up in a stack to be pressed with the core layer (321, 322) and a protective layer, and preferably also a balancing layer. It is of course not excluded that the method of the invention would form part of a CPL (Compact Laminate) or an HPL (High Pressure Laminate) process in which the decorative layer is hot pressed at least with a plurality of resin impregnated core paper layers, e.g. of so called Kraft paper, forming a substrate underneath the decorative layer, and wherein the obtained pressed and cured laminate layer, or laminate board is, in the case of an HPL, glued to a further substrate, such as to a particle board or an MDF or HDF board.

In a preferred embodiment, a protective layer containing a thermosetting resin is applied onto respectively the first and/or second decorative layer (301, 302), wherein the thermosetting resin may be a colored thermosetting resin to reduce the amount of inkjet ink to be printed. The preferred ink set is a pigmented aqueous inkjet ink set and not a pigmented free radical UV curable ink set because these are not very well compatible with the usage of thermosetting resin in this method.

The method of manufacturing a decorative panel preferably includes:

providing a relief in at least the protective layer, more preferably by means of a short cycle embossing press and most preferably by a digital embossing press. The embossing preferably takes place at the same time that the core layer (321, 322), the first decorative layer (301) and the protective layer, and preferably one or more balancing layers, are heat-pressed together. The relief in the protective layer preferably corresponds to the rendered decorative image from the first decorative layer (301). This is analogue for the second decorative layer (302) from the present invention.

A decorative panel, may have a tongue and groove join and includes preferably at least a core layer (321, 322), a first decorative layer (301), comprising the decorative image and a protective layer. In order to protect the colour image of the first decorative layer (301) against wear, a protective layer is applied on top of the decorative layer. A balancing layer may also be applied at the opposite side of the core layer (321, 322) to restrict or prevent possible bending of the decorative panel. The assembly into a decorative panel of the balancing layer, the core layer (321, 322), the decorative layer and the protective layer is preferably performed in the same heat-press treatment of preferably a DPL process (Direct Pressure Laminate). This is analogue for the second decorative layer (302) from the present invention.

The type of tongue and groove may also be added to the print job

In a preferred embodiment of decorative panels, tongue and groove profiles are milled into the side of individual decorative panels, which allow them to be slid into one another. The tongue and groove join ensures, in the case of flooring panels, a sturdy floor construction and protects the floor, preventing dampness from penetrating.

The top surface of the decorative panel is preferably provided with a relief matching the decorative image, such as for example to accentuate the wood grain, cracks and nuts in the decorative image. Embossing techniques to accomplish such relief are well-known and disclosed by, for example, EP 1290290 A (FLOORING IND), US 2006144004 (UNILIN), EP 1711353 A (FLOORING IND) and US 2010192793 (FLOORING IND).

### b) Core Layers for Decorative Panels

The core layer (321, 322) is preferably made of wood-based materials, such as particle board, MDF or HDF (Medium Density Fibreboard or High Density Fibreboard), Oriented Strand Board (OSB) or the like. Use can also be made of boards of synthetic material or boards hardened by means of water, such as cement boards. In a particularly preferred embodiment, the core layer (321, 322) is a MDF or HDF board. Chipboard, plywood or even solid wood may also be used as core layer (321, 322). Solid wood as core layer (321, 322) is not preferred because this may shrink and cause undulations to appear on the surface of the decorative panel, chipboards and plywood is most preferred especially for specific decorative panel requirements such as: stability, flatness, rigidity, mechanical properties, uniformity of thickness, water and humidity resistance and fire performance properties.

The core layer (321, 322) may also be assembled at least from a plurality of paper sheets, or other carrier sheets, impregnated with a thermosetting resin as disclosed by WO 2013/050910 (UNILIN). Preferred paper sheets include so-called Kraft paper obtained by a chemical pulping process also known as the Kraft process, e.g. as described in U.S. Pat. No. 4,952,277 (BET PAPERCHEM). A core layer may also be impregnated by a resin.

In another preferred embodiment, the core layer (321, 322) is a board material composed substantially of wood fibres, which are bonded by means of a polycondensation glue, wherein the polycondensation glue forms 5 to 20 percent by weight of the board material and the wood fibres are obtained for at least 40 percent by weight from recycled wood. Suitable examples are disclosed by EP 2374588 A (UNILIN).

Instead of a wood based core layer, also a synthetic core layer may be used, such as those disclosed by US 2013062006 (FLOORING IND). In a preferred embodiment, the core layer (321, 322) comprises a foamed synthetic material, such as foamed polyethylene or foamed polyvinyl chloride.

Other preferred core layers (321, 322) and their manufacturing are disclosed by US 2011311806 (UNILIN) and U.S. Pat. No. 6,773,799 (DECORATIVE SURFACES).

The thickness of the core layer (321, 322) is preferably between 2 and 12 mm, more preferably between 5 and 10 mm.

### c) Paper Substrates for Decorative Panels

The first and/or decorative layer and preferably also the protective layer and/or the optional balancing layer, include paper as substrate. In the present invention the substrate is a web substrate coming from a roll supplied to the web-fed inkjet print system. The substrate, comprised in the first decorative layer (301) of the present invention, may be a different than the substrate, comprised in the second decorative layer (302) of the present invention. The possibility to supply different substrates in the web-fed inkjet print system makes that the invention is user friendly, have multi-purpose probabilities, easily manageable and employable in manufacturing lines with several heat presses having different configurations.

The paper preferably has a weight of less than 150 g/m2, because heavier paper sheets are hard to impregnate all through their thickness with a thermosetting resin. Preferably said paper layer has a paper weight, i.e. without taking into account the resin provided on it, of between 50 and 100 g/m² and possibly up to 130 g/m². The weight of the paper cannot be too high, as then the amount of resin needed to sufficiently impregnate the paper would be too high, and reliably further processing the printed paper in a pressing operation becomes badly feasible.

Preferably, the paper has a porosity according to Gurley's method (DIN 53120) of between 8 and 20 seconds. Such porosity allows even for a heavy sheet of more than 150 g/m² to be readily impregnated with a relatively high amount of resin.

Suitable paper has a high porosity and their manufacturing are also disclosed by U.S. Pat. No. 6,709,764 (ARJO WIGGINS).

The paper for the first and/or decorative layer is preferably a white paper and may include one or more whitening agents, such as titanium dioxide, calcium carbonate and the like. The presence of a whitening agent helps to mask differences in colour on the core layer (321, 322), which can cause undesired colour effects on the decorative image.

Alternatively, the paper for the decorative layer is preferably a bulk coloured paper including one or more colour dyes and/or colour pigments. Besides the masking of differences in colour on the core layer (321, 322), the use of a coloured paper reduces the amount of inkjet ink required to rendered decorative image. For example, a light brown or grey paper may be used for rendering a decorative image order to reduce the amount of inkjet ink needed.

In a preferred embodiment, unbleached Kraft paper is used for a brownish coloured paper in the decorative layer. Kraft paper has a low lignin content resulting in a high tensile strength. A preferred type of Kraft paper is absorbent Kraft paper of 40 to 135 g/m² having high porosity, and made from clean low kappa hardwood Kraft of good uniformity.

If the protective layer includes a paper, then a paper is used which becomes transparent or translucent after resin impregnation so that the decorative image in the decorative layer can be viewed.

The above papers may also be used in the balancing layer.

### d) Ink Receiving Layer for Decorative Panels

One or more ink receiving layers may be present on the paper substrate of the decorative layer for enhancing the image quality.

The ink receiving layer(s) may be a purely polymer based ink receiving layer, but preferably contain an inorganic pigment and a polymeric binder. The inorganic pigment may be a single type of inorganic pigment or a plurality of different inorganic pigments. The polymeric binder may be a single type of polymeric binder or a plurality of different polymeric binders.

In a preferred embodiment, the ink receiving layer(s) have a total dry weight between 2.0 g/m² and 10.0 g/m², more preferably between 3.0 and 6.0 g/m².

In a particularly preferred embodiment, the ink receiving layer(s) include a polymeric binder, preferably a water soluble polymeric binder (>1 g/L water at 25° C.), which has a hydroxyl group as a hydrophilic structural unit, e.g. a polyvinyl alcohol.

The inorganic pigment is preferably selected from the group consisting of alumina hydrates, aluminum oxides, aluminum hydroxides, aluminum silicates, and silicas.

Particularly preferred inorganic pigments are silica particles, colloidal silica, alumina particles and pseudo-boehmite, as they form better porous structures. When used herein, the particles may be primary particles directly used as they are, or they may form secondary particles. Preferably, the particles have an average primary particle diameter of 2 μm or less, and more preferably 200 nm or less.

Another preferred type of inorganic pigment is silica, which can be used as such, in its anionic form or after cationic modification. The silica can be chosen from different types, such as crystalline silica, amorphous silica, precipitated silica, fumed silica, silica gel, spherical and non-spherical silica.

In a further preferred embodiment, said ink receiving layer can be further crosslinked. Any suitable crosslinker known in the prior art can be used. Boric acid is particularly preferred as crosslinker for the ink receiving layer according to the present invention.

The ink receiving layer(s) may include other additives, such as colorants, surfactants, biocides, antistatic agents, hard particles for wear resistance, elastomers, UV absorbers, organic solvents, plasticizers, light-stabilizers, pH adjusters, antistatic agents, whitening agents, matting agents and the like.

The ink receiving layer(s) may consist of a single layer or of two, three or more layers even having a different composition. The ink receiving layer(s) may be coated onto the support side of the substrate by any conventional coating technique, such as dip coating, knife coating, extrusion coating, spin coating, slide hopper coating and curtain coating. Alternatively, the ink receiving layer(s) can also be applied by a printing technique, such as flexographic printing, screen printing and inkjet printing technology such as valvejet printheads.

It is found that thickness of ink receiving layer; the temperature of heat pressing and pressure of heat pressure influences the decorative image quality comprised in the decorative panel. Thus for a certain thickness of ink receiving layer, another temperature/pressure setting is needed. The switching between these settings may take too long so another heating may be used, whereby thus the present invention is a solution.

### e) Thermosetting Resins for Decorative Panels

The thermosetting resin in the present invention is preferably selected from the group consisting of melamine-formaldehyde based resins, ureum-formaldehyde based resins and phenol-formaldehyde based resins.

Most preferably the thermosetting resin is a melamine-formaldehyde based resin, often simply referred to in the art as a ‘melamine (based) resin’.

The melamine formaldehyde resin preferably has a formaldehyde to melamine ratio of 1.4 to 2. Such melamine based resin is a resin that polycondensates while exposed to heat in a pressing operation. The polycondensation reaction creates water as a by-product. It is particularly with these kinds of thermosetting resins, namely those creating water as a by-product, that the present invention is of interest. The created water, as well as any water residue in the thermosetting resin before the pressing, must leave the hardening resin layer to a large extent before being trapped and leading to a loss of transparency in the hardened layer. The available ink layer can hinder the diffusion of the vapour bubbles to the surface, resulting in adhesion problems.

The paper is preferably provided with an amount of thermosetting resin equalling 40 to 250% dry weight of resin as compared to weight of the paper. Experiments have shown that this range of applied resin provides for a sufficient impregnation of the paper, that avoids splitting to a large extent, and that stabilizes the dimension of the paper to a high degree.

The paper is preferably provided with such an amount of thermosetting resin that at least the paper core is satisfied with the resin. Such satisfaction can be reached when an amount of resin is provided that corresponds to at least 1.5 or at least 2 times the paper weight.

Preferably the resin provided on said paper is in a so-called B-stage. Such B-stage exists when the thermosetting resin is not completely cross linked.

Preferably the resin provided on said paper has a relative humidity lower than 15%, and still better of 10% by weight or lower.

Preferably the step of providing said paper with thermosetting resin involves applying a mixture of water and the resin on the paper. The application of the mixture might involve immersion of the paper in a bath of the mixture and/or spraying or jetting the mixture. Preferably the resin is provided in a dosed manner, for example by using one or more squeezing rollers and/or doctor blades to set the amount of resin added to the paper layer.

Methods for resin-impregnating a paper substrate with resin are well-known in the art as exemplified by WO 2012/126816 (VITS).

### f) Decorative Layer for Decorative Panels

The decorative layer includes a substrate, such as a paper and a decorative image printed by inkjet technology. In the assembled decorative panel, the jetted decorative image is located on the paper on the opposite side than the side facing the core layer (321, 322). The paper may be impregnated with thermosetting resin after the printing of the decorative image or may be impregnated with thermosetting resin before printing the decorative image.

A decorative panel, like a floor panel, preferably has on one side of the core layer (321, 322) a decorative layer and a balancing layer on the other side of the core layer (321, 322). However, a decorative layer may be applied on both sides of the core layer (321, 322). The latter is especially desirable in the case of laminate panels for furniture. In such a case, preferably also a protective layer is applied on both decorative layers present on both sides of the core layer (321, 322).

The jetted decorative image is obtained by jetting and drying one or more aqueous inkjet inks of an aqueous inkjet ink set upon the one or more ink receiving layers.

### g) Protective Layer for Decorative Panels

A protective layer is applied above the rendered wood patter, e.g. by way of an overlay, i.e. a resin provided carrier, or a liquid coating, preferably while the decor layer is laying on the core layer (321, 322), either loosely or already connected or adhered thereto.

In a preferred embodiment, the carrier of the overlay is a paper impregnated by a thermosetting resin that becomes transparent or translucent after heat pressing in a DPL process. A preferred method for manufacturing such an overlay is described in US 2009208646 (DEKOR-KUNSTSTOFFE).

The liquid coating includes preferably a thermosetting resin, but may also be another type of liquid such as a UV- or an EB-curable varnish. In a particularly preferred embodiment, the liquid coating includes a melamine resin and hard particles, like corundum.

The protective layer is preferably the outermost layer, but in another embodiment a thermoplastic or elastomeric surface layer may be coated on the protective layer, preferably of pure thermoplastic or elastomeric material. In the latter case, preferably a thermoplastic or elastomeric material based layer is also applied on the other side of the core layer (321, 322).

Preferably, the step of providing the protective layer of thermosetting resin above the printed image involves a press treatment. Preferably, a temperature above 150° C. is applied in the press treatment, more preferably between 180° and 220° C., and a pressure of more than 20 bar, more preferably between 35 and 40 bar.

### h) Balancing Layer for Decorative Panels

The main purpose of the balancing layer(s) is to compensate tensile forces by layers on the opposite side of the core layer (321, 322), so that an essentially flat decorative panel is obtained. Such a balancing layer is preferably a thermosetting resin layer, which can comprise one or more carrier layers, such as paper sheets.

As already explained above for a furniture panel, the balancing layer(s) may be a decorative layer, optionally complemented by a protective layer.

Instead of one or more transparent balancing layers, also an opaque balancing layer may be used which gives the decorative panel a more appealing look by masking surface irregularities. Additionally, it may contain text or graphical information such as a company logo or text information.

i) Postforming

The manufacturing of decorative panels may be comprising the step of postforming, on a curved core layer for the manufacturing of decorative panels without sharp corners. Sharp corners may created places wherein water or dirt can accumulate which is on heat pressing on curved core layer prevented. Such decorative panels are sometimes called hot-form postforming decorative panels. The temperature of the heat press is therefore controlled very accurately so no breaking or cracking, delamination, forming of blisters occur on/in the decorative panel.

If the meta-data of the print job/decorative image comprises that it is for the manufacturing of such hot-form postforming decorative panels than from this meta-data the correct heat press and/or a print-zone allocated to the correct heat press may be assigned.

In the process of manufacturing such decorative panels, it is of a big importance that temperature is monitored and controlled. The temperature depends namely on the radius of the curvature, thickness of the decorative layer, the pressure of the heat press on the decorative layer, coverage of the decorative image on the decorative layer and the humidity of the decorative layer. The monitoring of temperature can be for example achieved by infrared detectors.

The heat-pressing step may be carried out with infrared equipment, heated plates or heated bars or heated metal tubing which is similar as in the heat-pressing step of the embodiments and preferred embodiments in the present invention.

The decorative layer is preferably first postformed and then bonded to the core layer or other layers by the heat press.

### Decorative Vinyl Tiles

Manufacturing of decorative vinyl tiles, an example of the decorative panels from the present invention, wherein images are rendered by inkjet technology is disclosed in detail in WO2016188745 (AGFA GRAPHICS).

Hereby is the water resistance important, e.g. a personalized decorative floor in a bathroom, the paper substrate from the above described manufacturing method of decoration panel is preferably replaced by a thermoplastic substrate based on a material selected from the group consisting of polyvinylchloride (PVC), polypropylene (PP), polyethylene (PE), polyethylene-terephthalate (PET) and thermoplastic polyurethane (TPU) and combinations thereof. Most preferably PVC is used as thermoplastic substrate. Conventional decorative laminate panels of the PVC are known in the industry as LVT, an abbreviation used for Luxury Vinyl Tiles. In a preferred embodiment, the decorative image is inkjet printed using one or more free radical UV curable inkjet inks instead of solvent based inkjet inks as this brings not only economical and environmental advantages, but also for image quality as UV curing can freeze the jetted image.

Decorative vinyl tiles are constructed together for a large planar surface, such as floor or wall.

The advantage of decorative vinyl tiles is their possibility to decorate in a wet environment, such as bathrooms, floorings and walls.

### a) Manufacturing Decorative Vinyl Tiles

In a preferred embodiment the method of manufacturing decorative panels of the present invention additional comprises a step of heat pressing the first and/or second decorative layer (301, 302) and an other substrate wherein the other substrate and the decorative layers are a thermoplastic foil. The preferred ink set is a set of free radical UV curable ink and not a pigmented aqueous inkjet ink set because the adhesion of such inkjet inks on thermoplastic foil is not guaranteed and may result in delamination.

The method for manufacturing decorative vinyl tiles, most preferably comprises, in order, the steps of:

a) inkjet printing a decorative image on a first thermoplastic foil, as substrate, by jetting and UV curing one or more pigmented free radical UV curable inkjet inks on the first thermoplastic foil to form the first and/or second decorative layer (302).:

b) applying on the rendered decorative image a second thermoplastic foil carrying a layer containing a vinylchloride-vinylacetate-vinylalcohol copolymer with the decorative layer facing the inkjet printed decorative image on the first thermoplastic foil; and

c) heat pressing the first and second thermoplastic foils into a decorative panel; wherein at least one of the first and second thermoplastic foils is a transparent thermoplastic foil; and wherein the one or more pigmented free radical UV curable inkjet inks contain a polymerizable composition having: 30 to 90 wt % of one or more compounds with one ethylenically unsaturated polymerizable group; 10 to 70 wt % of one or more compounds with two ethylenically unsaturated polymerizable groups; and 0 to 10 wt % of one or more compounds with three or more ethylenically unsaturated polymerizable groups, wherein all weight percentages wt % are based upon the total weight of the polymerizable composition.

The above method includes an additional step d) of cutting the decorative panel into one or more decorative vinyl tiles. The method of the invention can also be used to manufacture broadloom decorative surfaces (e.g. vinyl rolls), but is preferably used for manufacturing decorative panels, as the latter do not require experienced workers for their application and removal of all furniture from a room.

The foils are thermoplastic so that they can be fused together during heat-pressing. Heat pressing is preferably performed by preheating the first and second thermoplastic foils preferably to a temperature above 130° C., more preferably between 140 and 170° C., and preferably then using a cooled press to fuse them into a decorative panel. Alternatively, the press containing the first and second thermoplastic foils may be heated to a temperature above 130° C., followed by cooling the press to fuse the first and second thermoplastic foils into a decorative panel. The pressure used in both methods is preferably more than 10 bar, more preferably between 15 and 40 bar.

The thermoplastic foils are preferably selected from the groups consisting of polyvinyl chloride (PVC), polyolefins like polyethylene (PE) and polypropylene (PP), polyamides (PA), polyurethane (PU), polystyrene (PS), acrylonitrile-butadiene-styrene (ABS), polymethyl methacrylate (PMMA), polycarbonate (PC), polyethylene terephthalate (PET), polyetheretherketone (PEEK) or mixtures or co-polymers of these.

In a preferred embodiment, the first and second thermoplastic foils are polyvinyl chloride foils. The polyvinylchloride foils are preferably of the rigid type including less than 10 wt % of plasticizer, more preferably these PVC foils contain 0 to 5 wt % of plasticizer. The plasticizer may be a phthalate plasticizer, but is preferably a non-phthalate plasticizer for health reasons.

Preferred non-phthalate plasticizers include diisononyl cyclohexane-1,2-dicarboxylate (DINCH), dipropylene glycol dibenzoate (DGD), diethylene glycol dibenzoate (DEGD), triethylene glycol dibenzoate (TEGD), acetylated monoglycerides of fully hydrogenated castor oil (COMGHA) isosorbide esters, bis-(2-ethylhexyl) terephthalate, vegetable oil based plasticizers like Ecolibrium™ from DOW, and blends thereof.

In a preferred embodiment, is the decorative image inkjet printed with a set of pigmented UV curable inkjet inks cured by an UV source, preferably cured using one or more UV LEDs. Many light sources exist in UV radiation, including a high or low pressure mercury lamp, a cold cathode tube, a black light, an ultraviolet LED, an ultraviolet laser, and a flash light. Of these, the preferred source is one exhibiting a relatively long wavelength UV-contribution having a dominant wavelength of 300-400 nm. Specifically, a UV-A light source is preferred due to the reduced light scattering therewith resulting in more efficient interior curing. One or more of such light sources may be comprised in the web-fed inkjet print system.

### b) First Thermoplastic Foils for Decorative Vinyl Tiles

The first thermoplastic foil includes a thermoplastic foil and decorative image rendered thereon by inkjet technology.

The first thermoplastic foil preferably has a thickness of at least 80 μm. When the inkjet image is rendered on a transparent thermoplastic foil used as a protective outer layer of the decorative panel, it preferably has a thickness of more than 100 μm, more preferably 200 to 700 μm, and most preferably 300 to 500 μm.

If the first thermoplastic foil is used as a protective outer layer of the decorative panel, it may include additional finishing layers on its surface as described here below for the second thermoplastic foil.

### c) Second Thermoplastic Foils for Decorative Vinyl Tiles

The second thermoplastic foil preferably carries a layer contains a vinylchloride-vinylacetate-vinylalcohol copolymer. Such a layer assures optimal adhesion to the rendered decorative image while the flexibility can be maximized by using pigmented free radical UV curable inkjet inks having high amounts compounds with one ethylenically unsaturated polymerizable group in the polymerizable composition of the inkjet inks. The layer preferably includes a vinylchloride-vinylacetate-vinylalcohol copolymer containing more than 80 wt % of vinyl chloride and 1 to 15 wt % of vinylalcohol on the total weight of the copolymer. Another advantage of including the vinylalcohol in the specific vinylchloride-vinylacetate copolymer is that the layer becomes not tacky and the second thermoplastic foil can be stored as a roll without causing issues of stickiness.

The application of the layer may containing a vinylchloride-vinylacetate-vinylalcohol copolymer is preferably performed using a coating technique selected from spray coating, dip coating, knife coating, extrusion coating, spin coating, slide hopper coating and curtain coating.

The layer containing a vinylchloride-vinylacetate-vinylalcohol copolymer is applied to have a dry weight of preferably 1 to 10 g/m², more preferably 2 to 7 g/m², and most preferably 3 to 6 g/m². Less than 1 g/m² did not provide good adhesion, while above 10 g/m² problems of tackiness and stickiness could again be observed. A very consistent quality was obtained when coated at a dry weight of 2 to 6 g/m².

A coating solution of the vinylchloride-vinylacetate-vinylalcohol copolymer is preferably made using an organic solvent having a boiling point of no more than 95° C. at normal pressure. The organic solvent for the vinylchloride-vinylacetate-vinylalcohol copolymer is preferably selected from methyl ethyl ketone or ethyl acetate for minimizing explosion risk.

The second thermoplastic foil is preferably used in the decorative panel as the outer layer, thus forming a transparant protective layer for the viewable rendered decorative image. However, additional finishing layers may be applied upon the protective layer.

In a particular preferred embodiment, the decorative panel has a polyurethane finishing layer on the protective layer.

The second thermoplastic foil preferably has a thickness of at least 80 μm. When the second thermoplastic foil is used as a protective outer layer of the decorative panel, it preferably has a thickness of more than 100 μm, more preferably 200 to 700 μm, and most preferably 300 to 500 μm.

### d) Base Layers for Decorative Vinyl Tiles

In a preferred embodiment, the decorative panel includes a base layer. The base layer provides sufficient rigidness to the decorative panel, so that when e.g. a long rectangular decorative panel bends under its own weight, the panel does not break. For this reason, the base layer is preferably reinforced with fibres.

In a decorative panel, the base layer is attached to the side of the opaque thermoplastic foil of the first and second thermoplastic foils or attached to the side of a transparent thermoplastic foil if both the first and second thermoplastic foils are transparent thermoplastic foils.

In a preferred embodiment, the base layer includes substantially polyvinyl chloride and reinforcing fibres. More preferably, the base layer includes substantially polyvinyl chloride and glass fibres.

The base layer may be composed of two foils, preferably polyvinyl chloride foils, interposed by a glass fibre fleece.

The base layer may contain mineral. Particularly suitable herein are as talc or calcium carbonate (chalk), aluminum oxide, silica. The base layer may include a flame retardant.

The base layer may also be a so-called woodplastic composite (WPC), preferably containing one or more polymers or copolymers selected from the group consisting polypropylene, polyethylene and polyvinyl chloride.

### Inks

The decorative image is inkjet printed with one or more inks, preferably a plurality of inks composed into an inkjet ink set having differently coloured inkjet inks (M inks, I_{1. . . M}). The inkjet ink set may be a standard CMYK ink set, but is preferably a CRYK inkjet ink set wherein the magenta (M) ink is replaced by red (R) inkjet ink. The use of a red inkjet ink enhances the colour gamut for decorative images. A decorative image has mainly a brown background color. The use of a red (R) inkjet ink is there for more preferred than magenta inkjet ink to save more ink.

The inkjet ink set may be extended with extra inks such as brown (BR), magenta (M), red (R), green (GR), blue (BL), and/or orange (OR) to further enlarge the colour gamut of the ink set. The inkjet ink set may also be extended by the combination of the full density inkjet inks with light density inkjet inks. The combination of such dark and light colour inks and/or black and grey inks improves the image quality by a lowered graininess.

The inkjet ink set may be a set of pigmented free radical UV curable inks or a set of pigmented aqueous inkjet inks.

### a) Pigmented Free Radical UV Curable Inks

In a preferred embodiment is the M inks (I_{1 . . . M}) from the present invention a plurality of pigmented free radical UV curable inks usable in inkjet technology, also called pigmented free radical UV curable inkjet inks. The decorative image is rendered using one or more pigmented free radical UV curable inkjet inks, preferably containing a polymerizable composition having 30 to 90 wt % of one or more compounds with one ethylenically unsaturated polymerizable group; 10 to 70 wt % of one or more compounds with two ethylenically unsaturated polymerizable groups; and

0 to 10 wt % of one or more compounds with three or more ethylenically unsaturated polymerizable groups, wherein all weight percentages wt % are based upon the total weight of the polymerizable composition.

In a particularly preferred embodiment, the amount of one or more compounds with one ethylenically unsaturated polymerizable group is larger than 72 wt %, more preferably larger than 80 wt %, wherein the weight percentage wt % is based on the total weight of the polymerizable composition.

In a preferred embodiment, the polymerizable compounds consist for more than 80 wt %, preferably more than 90 wt % of acrylates and optional N-vinyl lactams, wherein the weight percentage wt % is based on the total weight of the polymerizable composition. Such inkjet inks exhibit a high curing speed and are especially useful for UV LED curing.

In the most preferred embodiment, the inkjet inks do not contain intentionally added water or organic solvents, but may contain a very small amount of water, generally less than 5 wt % of water based on the total weight of the ink. This water was not intentionally added but came into the formulation via other components as a contamination, such as for example polar organic solvents. Higher amounts of water than 5 wt % of water based on the total weight of the ink often makes the inkjet inks instable, preferably the water content is less than 1 wt % based on the total weight of the ink and most preferably no water at all is present.

In a less preferred embodiment, the pigmented UV curable inkjet ink contains 20 to 60 wt % of organic solvent based on the total weight of the inkjet ink. In such a case, besides the UV curing means extra drying means for solvent evaporation becomes necessary.

### b) Polymerizable Compounds

The polymerizable compounds are preferably present in the pigmented UV curable inkjet inks in an amount of at least 60 wt %, more preferably at least 70 wt %, wherein the wt % is based on the total weight of the inkjet ink.

Any monomer and oligomer capable of free radical polymerization may be used as polymerizable compound. The viscosity of the UV curable inkjet ink can be adjusted by varying the ratio between the monomers and oligomers. The polymerizable compounds may be any monomer and/or oligomer found in the Polymer Handbook Vol 1+2, 4th edition, edited by J. BRANDRUP et al., Wiley-Interscience, 1999.

### c) Colorants

The colour pigments may be black, cyan, magenta, yellow, red, orange, violet, blue, green, brown, mixtures thereof, and the like. A colour pigment may be chosen from those disclosed by HERBST, Willy, et al. Industrial Organic Pigments, Production, Properties, Applications. 3^{rd} edition. Wiley—VCH, 2004. ISBN 3527305769.

A particularly preferred pigment for a cyan inkjet ink is a copper phthalocyanine pigment, more preferably C.I. Pigment Blue 15:3 or C.I. Pigment Blue 15:4.

Particularly preferred pigments for a red or magenta inkjet ink are C.I. Pigment Violet 19, C.I Pigment Red 254, C.I. Pigment Red 176, C.I. Pigment Red 202 and C.I. Pigment Red 122, and mixed crystals thereof.

Particularly preferred pigments for yellow inkjet ink are C.I Pigment Yellow 150, C.I. Pigment Yellow 155, C.I. Pigment Yellow 120 and C.I. Pigment Yellow 180, and mixed crystals thereof.

For the black ink, suitable pigment materials include carbon blacks, such as Regal™ 400R, Mogul™ L, Elftex™ 320 from Cabot Co., or C.I. Pigment Black 7 and C.I. Pigment Black 11.

The pigment is preferably used in the inkjet ink in an amount of 0.1 to 20 wt %, preferably 1 to 10 wt %, and most preferably 2 to 6 wt % based on the total weight of the pigmented inkjet ink. A pigment concentration of at least 2 wt % is preferred to reduce the amount of inkjet ink needed to produce the decorative image, while a pigment concentration higher than 5 wt % reduces the colour gamut for printing the decorative image with printheads having a nozzle diameter of 20 to 50 μm.

### d) Polymeric Dispersants

Pigmented inkjet ink preferably contains a dispersant, more preferably a polymeric dispersant for dispersing the pigment.

Typical polymeric dispersants are copolymers of two monomers but may contain three, four, five or even more monomers. The properties of polymeric dispersants depend on both the nature of the monomers and their distribution in the polymer. Suitable polymeric dispersants are listed in the section on “Dispersants”, more specifically [0064] to [0070] and [0074] to [0077], in EP 1911814 A (AGFA GRAPHICS).

The polymeric dispersant has preferably a number average molecular weight Mn between 500 and 30000, more preferably between 1500 and 10000. The polymeric dispersant has preferably a weight average molecular weight Mw smaller than 100,000, more preferably smaller than 50,000 and most preferably smaller than 30,000. The polymeric dispersant has preferably a polydispersity PD smaller than 2, more preferably smaller than 1.75 and most preferably smaller than 1.5. The polymeric dispersant is preferably used in an amount of 2 to 600 wt %, more preferably 5 to 200 wt %, most preferably 50 to 90 wt % based on the weight of the pigment.

### e) Photoinitiating System

A photoinitiating system is used for initiating the polymerization of the polymerizable composition in the inkjet inks. The photoinitiating system includes one or more photoinitiators and optionally one or more co-initiators.

The photoinitiator is a free radical initiator. A free radical photoinitiator is a chemical compound that initiates polymerization of monomers and oligomers when exposed to actinic radiation by the formation of a free radical.

In order to increase the photosensitivity further, the UV curable inkjet ink may additionally contain co-initiators. The preferred co-initiators are aminobenzoates.

### f) Polymerization Inhibitors

The UV curable inkjet ink may contain a polymerization inhibitor. Suitable polymerization inhibitors include phenol type antioxidants, hindered amine light stabilizers, phosphor type antioxidants, hydroquinone monomethyl ether commonly used in (meth)acrylate monomers, and hydroquinone, t-butylcatechol, pyrogallol may also be used.

Since excessive addition of these polymerization inhibitors will lower the ink sensitivity to curing, it is preferred that the amount capable of preventing polymerization is determined prior to blending. The amount of a polymerization inhibitor is preferably lower than 2 wt % based on the total weight of the inkjet ink.

### g) Surfactants

Surfactants are used in inkjet inks to reduce the surface tension of the ink fro example in order to reduce the contact angle on the thermoplastic foil, i.e. to improve the wetting of the foil by the ink. On the other hand, the inkjet ink must meet stringent performance criteria in order to be adequately jettable with high precision, reliability and during an extended period of time. To achieve both wetting of the substrate by the ink and high jetting performance, typically, the surface tension of the ink is reduced by the addition of one or more surfactants. In the case of UV curable inkjet inks, however, the surface tension of the inkjet ink is not only determined by the amount and type of surfactant, but also by the polymerizable compounds, the polymeric dispersants and other additives in the ink composition.

The surfactant(s) can be anionic, cationic, non-ionic, or zwitter-ionic and are usually added in a total quantity less than 20 wt % based on the total weight of the inkjet ink and particularly in a total less than 10 wt % based on the total weight of the inkjet ink.

Silicone surfactants are often preferred in curable inkjet inks, especially the reactive silicone surfactants, which are able to be polymerized together with the polymerizable compounds during the curing step.

### h) Preparation of Pigmented Free Radical UV Curable Inks

The preparation of pigmented UV curable inkjet inks is well-known to the skilled person. Preferred methods of preparation are disclosed in paragraphs [0076] to [0085] of WO 2011/069943 (AGFA).

### i) Pigmented Aqueous Inkjet Ink Sets

A pigmented aqueous inkjet ink set according to a preferred embodiment of the invention comprises:

a) a cyan aqueous inkjet ink containing a copper phthalocyanine pigment, preferably a β-copper phthalocyanine pigment;

b) a red aqueous inkjet ink containing a red pigment selected from the group consisting of C.I. Pigment Red 254, C.I. Pigment Red 122, C.I. Pigment Red 176 and mixed crystals thereof;

c) a yellow aqueous inkjet ink containing a pigment C.I Pigment Yellow 150 or a mixed crystal thereof; and

d) a black aqueous inkjet ink containing a carbon black pigment; wherein the aqueous inkjet inks contain a surfactant.

In addition to specific colour pigments, the inkjet inks contain also a surfactant, preferably a fluorosurfactant. The surfactant allows for spreading on the decor paper, which enhances indirectly also the metamerism. In a preferred embodiment of the pigmented aqueous inkjet ink set, the pigmented aqueous inkjet inks have a static surface tension at 25° C. between 19.0 mN·m and 27.0 mN·m for good spreading on the decor paper.

The hue angle H* of a red inkjet ink is normally in the range of 15° to 65°. For providing good reproduction of wood colour images, the hue angle H* of a red inkjet ink in the present invention is preferably between 15° and 50°, more preferably between 20° and 40°. In a preferred embodiment of the pigmented aqueous inkjet ink set, the red pigment is C.I. Pigment Red 254 or a mixed crystal thereof. The hue angle H* is calculated in CIELab color space by the formular: tan-1(b*/a*) (degree) wherein a* and b* are the chromaticity coordinates in the CIE Lab color space.

The hue angle of a yellow inkjet ink is usually in the range of 75° to 110°. For providing good reproduction of wood colour images, the hue angle H* of a yellow inkjet ink in the present invention is preferably between 80° and 105°, more preferably between 85° and 95°. In a preferred embodiment of the pigmented aqueous inkjet ink set, the hue angle H* of the yellow aqueous inkjet ink is higher than 85°, more preferably between 86° and 98°, and most preferably between 87° and 95°.

The pigmented aqueous inkjet inks in the ink set should preferably also have a chroma C* of at least more than 50.

A pigmented aqueous ink may comprise a biocide a,d/or at least one pH adjuster, such as NaOH, KOH, NEt3, NH3, HCl. Preferred pH adjusters are triethanol amine, NaOH and H2SO4.

### j) Preparation of Pigmented Aqueous Inks

The one or more aqueous inkjet inks may be prepared by precipitating or milling the colour pigment in the dispersion medium in the presence of the polymeric dispersant, or simply by mixing a self-dispersible colour pigment in the ink. Mixing apparatuses may include a pressure kneader, an open kneader, a planetary mixer, a dissolver, and a Dalton Universal Mixer. Suitable milling and dispersion apparatuses are a ball mill, a pearl mill, a colloid mill.

If the inkjet ink contains more than one pigment, the colour ink may be prepared using separate dispersions for each pigment, or alternatively several pigments may be mixed and co-milled in preparing the dispersion. The dispersion process can be carried out in a continuous, batch or semi-batch mode. The milling time can vary widely and depends upon the pigment, selected mechanical means and residence conditions, the initial and desired final particle size, etc. In the present invention, pigment dispersions with an average particle size of less than 100 nm may be prepared.

After milling is completed, the milling media is separated from the milled particulate product (in either a dry or liquid dispersion form) using conventional separation techniques, such as by filtration, sieving through a mesh screen, and the like.

### k) Polymer Latex Binders

One or more of the aqueous inkjet inks may contain a polymer latex binder, preferably a polyurethane based latex. It was observed that polyurethane based latex are less detrimental for adhesion in flooring laminates than acrylic latex binders.

The polymer latex binder is not particularly limited as long as it has stable dispersibility in the ink composition. There is no limitation on the main chain skeleton of the water-insoluble polymer.

In the preferred embodiment, the polymer latex is a polyurethane latex, more preferably a self-dispersible polyurethane latex. The polymer latex binder in the one or more aqueous inkjet inks is preferably a polyurethane based latex binder for reasons of compatibility with the thermosetting resin; when used in the manufacturing of decorative panels (331, 332).

The latex binder polymer particles preferably have a glass transition temperature (Tg) of 30° C. or more. The minimum film-forming temperature (MFT) of the polymer latex is preferably −25 to 150° C., and more preferably 35 to 130° C.

### I) Jetting Viscosity and Jetting Temperature

The jetting viscosity is measured by measuring the viscosity of the liquid at the jetting temperature. The jetting viscosity may be measured with various types of viscometers such as a Brookfield DV-II+ viscometer at jetting temperature and at 12 rotations per minute (RPM) using a CPE 40 spindle which corresponds to a shear rate of 90 s-1 or with the HAAKE Rotovisco 1 Rheometer with sensor C60/1 Ti at a shear rate of 1000 s-1.

In a preferred embodiment, the jetting viscosity is from 10 mPa·s to 200 mPa·s more preferably from 25 mPa·s to 100 mPa·s and most preferably from 30 mPa·s to 70 mPa·s.

The jetting temperature may be measured with various types of thermometers. The jetting temperature of jetted liquid is measured at the exit of a nozzle in the printhead while jetting or it may be measured by measuring the temperature of the liquid in the liquid channels or nozzle while jetting through the nozzle. In a preferred embodiment, the jetting temperature is from 10° C. to 100° C. more preferably from 20° C. to 60° C. and most preferably from 30° C. to 50° C.

### Inkjet Printhead Unit (500)

The web-fed inkjet print system comprises an inkjet printhead unit (500) for printing with an ink-set a decorative image.

An inkjet printhead unit (500) is a unit, which comprises a plurality of inkjet printheads. A printhead is a means for jetting a liquid on a substrate through a nozzle. The nozzle may be comprised in a nozzle plate, which is attached to the printhead. A plurality of nozzles in a printhead forms one or more nozzle rows. The inkjet printhead unit (500) in the present invention is attached to a web-fed inkjet print system to mark by inkjet technology a decorative image on a substrate. The web-fed inkjet print system is preferably capable of marking substrate with a width between 1 meter and 5 meter and if the substrate is not a web but a sheet, the web-fed inkjet print system is preferably capable of marking substrates with a height between 1 meter and 10 meter. More information about inkjet technology, incorporate printheads into an inkjet printhead unit (500) and web-fed inkjet print systems, which uses inkjet technology, are disclosed in STEPHEN F. POND. Inkjet Technology and Product Development Strategies. USA: Torrey Pines Research, 2000 and disclosed in Handbook of Industrial Inkjet Printing: A Full System Approach”, edited by Werner Zapka (publisher Wiley-VCH Verlag GmbH & Co, 22/11/2017, 984 pages).

A printhead preferably has a plurality of nozzles and one or more nozzle rows, which may be comprised in a nozzle plate. A set of liquid channels, comprised in the printhead, corresponds to a nozzle of the printhead, which means that the liquid in the set of liquid channels can leave the corresponding nozzle in the rendering method. The liquid is preferably an ink, more preferably a pigmented free radical UV curable ink or pigmented aqueous inkjet ink. The liquid used for jetting is also called a jettable liquid or inkjet ink. A high viscosity jetting method with UV curable inkjet ink is called a high viscosity UV curable jetting method. A high viscosity jetting method with water based inkjet ink is called a high viscosity water base jetting method.

Typically the jetting viscosity of the state of the art for jettable liquids is from 3 mPa·s to 15 mPa·s. None of the inkjet inks used in the field described above, such as commercial/transactional inkjet printing or wide format inkjet printing have a jetting viscosity larger than 15 mPa·s. An increase of jetting ink viscosity could allow to improve the adhesion on several ink receivers such as textiles or glasses, due to a larger choice in raw materials. This formulation latitude of the jettable liquid allows, for example, to include oligomers and/or polymers and/or pigments in a higher amount. This results in a wider accessible receiver range; reduced odour and migration and improved cure speed for UV curable jettable liquids; environmental, health and safety benefits (EH&S); physical properties benefits; reduced raw material costs and/or reduced ink consumption for higher pigment loads.

The way to incorporate printheads into an inkjet printhead unit (500) is well-known to the skilled person but also disclosed in STEPHEN F. POND. Inkjet Technology and Product Development Strategies. USA: Torrey Pines Research, 2000.

In the present invention is the decorative image preferably rendered in a plurality of print passes by inkjet technology because rendering a decorative image in one pass by inkjet technology suffers in daily production of decorative panels from operation failures such as failing nozzles in the inkjet printhead unit (500), thereby creating ‘empty’ line artefacts in the rendered decorative image and leading to waste of material by a cumbersome removal of these defective decorative panels after heat pressing. These web-fed inkjet print systems contain a serious amount of inkjet printheads in the inkjet printhead unit (500) to cover the whole width of the substrate, which makes it a very costly machine.

A printhead may be any type of inkjet head such as a Valvejet printhead, piezoelectric inkjet printhead, thermal inkjet printhead, a continuous inkjet printhead type, electrostatic drop on demand inkjet printhead type or acoustic drop on demand inkjet printhead type or a page-wide inkjet printhead array, also called a page-wide inkjet array.

Preferably, the printhead comprises a set of master outlets to perform a recirculation of the liquid through the printhead. The recirculation may be done before the droplet forming means but it is more preferred that the recirculation is done in the printhead itself, so called through-flow printheads. The continuous flow of the liquid in a through-flow printheads removes air bubbles and agglomerated particles from the liquid channels of the printhead, thereby avoiding blocked nozzles that prevent jetting of the liquid.

The printhead of the present invention is preferably suitable for jetting a liquid having a jetting viscosity of 8 mPa·s to 3000 mPa·s. A preferred printhead is suitable for jetting a liquid having a jetting viscosity of 20 mPa·s to 200 mPa·s; and more preferably suitable for jetting a liquid having a jetting viscosity of 50 mPa·s to 150 mPa·s.

### Piezoelectric Inkjet Printheads

A preferred printhead for the present invention is a piezoelectric inkjet printhead. Piezoelectric inkjet printhead, also called piezoelectric inkjet printhead, is based on the movement of a piezoelectric ceramic transducer, comprised in the printhead, when a voltage is applied thereto. The application of a voltage changes the shape of the piezoelectric ceramic transducer to create a void in a liquid channel, which is then filled with liquid. When the voltage is again removed, the ceramic expands to its original shape, ejecting a droplet of liquid from the liquid channel.

The droplet forming means of a piezoelectric inkjet printhead controls a set of piezoelectric ceramic transducers to apply a voltage to change the shape of a piezoelectric ceramic transducer. The droplet forming means may be a squeeze mode actuator, a bend mode actuator, a push mode actuator or a shear mode actuator or another type of piezoelectric actuator.

Suitable commercial piezoelectric inkjet printheads are TOSHIBA TEC™ CK1 and CK1L from TOSHIBA TEC™ (http://www.toshibatec.com/en/products/industrial/inkjet/products/) and XAAR™ 2001 from XAAR™ (http://www.xaar.com/en/products/).

A liquid channel in a piezoelectric inkjet printhead is also called a pressure chamber. Between a liquid channel and a master inlet of the piezoelectric inkjet printheads, there is a manifold connected to store the liquid to supply to the set of liquid channels.

The piezoelectric inkjet printhead is preferably a through-flow piezoelectric inkjet printhead. In a preferred embodiment the recirculation of the liquid in a through-flow piezoelectric inkjet printhead flows between a set of liquid channels and the inlet of the nozzle wherein the set of liquid channels corresponds to the nozzle.

In a preferred embodiment in a piezoelectric inkjet printhead the minimum drop size of one single jetted droplet is from 0.1 pL to 300 pL, in a more preferred embodiment the minimum drop size is from 1 pL to 30 pL, in a most preferred embodiment the minimum drop size is from 1.5 pL to 15 pL. By using grayscale inkjet head technology multiple single droplets may form larger drop sizes.

In a preferred embodiment the piezoelectric inkjet printhead has a native print resolution from 25 DPI to 2400 DPI, in a more preferred embodiment the piezoelectric inkjet printhead has a native print resolution from 50 DPI to 2400 DPI and in a most preferred embodiment the piezoelectric inkjet printhead has a native print resolution from 150 DPI to 3600 DPI. DPI is the abbreviation of dots per inch, which is a well-known measure of spatial prining, in particular the number of individual dots that can be place in a line within the span of 1 inch, which is 2.54 cm.

In a preferred embodiment with the piezoelectric inkjet printhead the jetting viscosity is from 8 mPa·s to 200 mPa·s more preferably from 25 mPa·s to 100 mPa·s and most preferably from 30 mPa·s to 70 mPa·s.

In a preferred embodiment with the piezoelectric inkjet printhead the jetting temperature is from 10° C. to 100° C. more preferably from 20° C. to 60° C. and most preferably from 30° C. to 50° C.

### Drying Devices

A dryer may be included in the web-fed inkjet print system for removing at least part of the used inkjet inks for printing a decorative image, e.g. aqueous medium of aqueous inkjet inks. Suitable dryers include devices circulating hot air, ovens, and devices using air suction.

The drying device may include a heat conduction device, such as a hot plate or a heat drum. A preferred heat drum is an induction heat drum.

The drying device may include an infrared radiation source. An effective infrared radiation source has an emission maximum between 0.8 and 1.5 μm. Such an infrared radiation source is sometimes called a NIR radiation source or NIR dryer.

NIR-radiation energy quickly enters into the depth of the inkjet ink layer and removes water and solvents out of the whole layer thickness, while conventional infrared and thermo-air energy predominantly is absorbed at the surface and slowly conducted into the ink layer, which results usually in a slower removal of water and solvents.

In a preferred embodiment, the NIR radiation source is in the form of NIR LEDs, which can be mounted easily on a shuttling system of a plurality of inkjet print heads in a multi pass web-fed inkjet print system.
Another preferred drying device uses Carbon Infrared Radiation (CIR).

### UV Curing Devices

The UV curing device emits UV radiation that is absorbed by the photoinitiator or photoinitiating system for polymerizing the polymerizable compounds of the core. Such UV vuring device is attached to the web-fed inkjet print system of the present invention if pigmented free radical UV curable inks are used for printing the decorative image on a substrate to form the first or second decorative layer (301, 302).

The UV curing device may include a high or low pressure mercury lamp, but preferably includes or consists of UV LEDs.

The UV curing device may be arranged in combination with the inkjet printhead or inkjet printhead unit (500) of the web-fed inkjet print system, travelling therewith so that the curing radiation is applied very shortly after jetting. Preferably such curing means consists of one or more UV LEDs, because in such an arrangement it can be difficult to provide other types of curing means that are small enough to be connected to and travelling with the print head. Alternatively, a static fixed radiation source may be employed, e.g. a source of curing UV-light, connected to the radiation source by means of flexible radiation conductive means, such as a fibre optic bundle or an internally reflective flexible tube, or by an arrangement of mirrors including a mirror upon the print head.

However, it is not necessary to have the UV light source connected to the print head. The source of UV radiation may, for example, also be an elongated radiation source extending transversely across the substrate to be cured. It may be adjacent to the transverse path of the print head so that subsequent rows of the decorative image formed by the print head are passed, stepwise or continually, beneath that radiation source.

Any ultraviolet light source, as long as part of the emitted light can be absorbed by the photoinitiator or photoinitiator system, may be employed as a radiation source, such as a high or low pressure mercury lamp, a cold cathode tube, a black light, an ultraviolet LED, an ultraviolet laser, and a flash light. Of these, the preferred source is one exhibiting a relatively long wavelength UV-contribution having a dominant wavelength of 300-400 nm.

Specifically, a UV-A light source is preferred due to the reduced light scattering therewith resulting in more efficient interior curing.

UV radiation is generally classed as UV-A, UV-B, and UV-C as follows:

UV-A: 400 nm to 320 nm

UV-B: 320 nm to 290 nm

UV-C: 290 nm to 100 nm.

In a preferred embodiment, the web-fed inkjet print system contains one or more UV LEDs with a wavelength larger than 360 nm, preferably one or more UV LEDs with a wavelength larger than 380 nm, and most preferably UV LEDs with a wavelength of about 395 nm.

Furthermore, it is possible to cure the image using, consecutively or simultaneously, two light sources of differing wavelength or illuminance. For example, the first UV-source can be selected to be rich in UV-C, in particular in the range of 260 nm-200 nm. The second UV-source can then be rich in UV-A, e.g. a gallium-doped lamp, or a different lamp high in both UV-A and UV-B. The use of two UV-sources has been found to have advantages e.g. a fast curing speed and a high curing degree.

For facilitating curing, the web-fed inkjet print system often includes one or more oxygen depletion units. The oxygen depletion units place a blanket of nitrogen or other relatively inert gas (e.g. CO₂), with adjustable position and adjustable inert gas concentration, in order to reduce the oxygen concentration in the curing environment. Residual oxygen levels are usually maintained as low as 200 ppm, but are generally in the range of 200 ppm to 1200 ppm.

### Deco Workflow System

To manage the print jobs for the manufacturing decorative panels this may include rendering of decorative images by one or more digital render devices in a method of manufacturing decorative panels, the embodiment may be performed by a deco workflow system, which for example carries out determining decorative images, color converting of decorative images, imposing or nesting a plurality of decorative images on the substrate and/or digital cutting decorative panels comprising the rendered decorative image. Workflow systems for rendering images on inkjet printers are known e.g. Asanti™ from Agfa™, which is a complete, automated sign & display production hub featuring Agfa Graphics' award-winning color management solution, integration with the latest version of Adobe PDF Print Engine (APPE), highly specific functionalities (e.g. nesting, proofing support) and fast, automatic pre-flighting. The deco workflow system may be something similar but much more extended for the manufacturing of decorative panels.

Rendering is a stage comprising the step of halftoning an image and transferring the halftoned image to a web-fed inkjet print system and marking the transferred halftoned image by the web-fed inkjet print system. Halftoning, sometimes called screening is converting a continuous-tone bitmap into a halftone (pattern of dots). Therefor the deco workflow system comprises a halftoning unit for halftoning and preferably comprises a RIP (raster image processor) for rasterizing vector graphics. It additionally comprises a color management system for converting decorative images to the colors of the inks from the web-fed inkjet print system. The deco workflow system comprises preferably a management information system (MIS) to provide information that the manufacturing of decorative panels require to manage themselves efficiently and effectively and to analyse and to facilitate strategic and operational activities.

The deco workflow system operates a program. Part or whole of the deco workflow system and/or the functional units or blocks thereof may be implemented in one or more circuits or circuitry, such as an integrated circuit(s) or as an LSI (large scale integration). Each functional unit or block of the deco workflow system may be individually made into an integrated circuit chip. Alternatively, part or whole of the functional units or blocks may be integrated and made into an integrated circuit chip.

A program, which is operated in the deco workflow system according to various preferred embodiments of the present invention, is a program controlling a processor in order to realize functions of the various preferred embodiments according to the present invention. Therefore, information which is handled by the deco workflow system is temporarily accumulated in a RAM at the time of the processing. Thereafter, the information may be stored in various types of circuitry in the form of ROMs and HDDs, and read out by circuitry within, or included in combination with, the deco workflow system as necessary, and modification or write-in is performed thereto. As a recording medium storing the program, any one of a semiconductor medium (for example, the ROM, a non-volatile memory card or the like), an optical recording medium (for example, a DVD, an MO, an MD, a CD, a BD or the like), and a magnetic recording medium (for example, a magnetic tape, a flexible disc or the like) may be used. Moreover, by executing the loaded program, the functions of the various preferred embodiments of the present invention are not only realized, but the functions of preferred embodiments of the present invention may be realized by processing the loaded program in combination with an operating system or other application programs, based on an instruction of the program. In the present invention is a decorative image stored in the deco workflow system in a memory, similar as the above-mentioned program.

Moreover, in a case of being distributed in a market, the program can be distributed by being stored in the portable recording medium, or the program can be transmitted to a server computer, which is connected through a network such as the Internet. In this case, a storage device of the server computer is also included in the present invention. In addition, a portion of a terminal device, a wireless base station, a host system, or other devices, or the whole thereof may be realized as an LSI, which is typically an integrated circuit. Each functional unit or block of the deco workflow system may be individually chipped, or a portion thereof, or the whole thereof may be chipped by being integrated. In a case of making each functional block or unit as an integrated circuit, an integrated circuit controller that controls the integrated circuits, is added.

Finally, it should be noted that the description referring to “circuit” or “circuitry” is in no way limited to an implementation that is hardware only, and as persons of ordinary skill in the relevant art would know and understand, such descriptions and recitations of “circuit” or “circuitry” include combined hardware and software implementations in which the circuit or circuitry is operative to perform functions and operations based on machine readable programs, software or other instructions in any form that are usable to operate the circuit or circuitry.

The print job and the according decorative image for the first print zone and first decorative layer (301) and the print job and the according decorative image for the second print zone and second decorative layer (302) may be transmitted separately to the inkjet print head unit from the web-fed inkjet print system. But preferably the both print jobs are firstly merged together by merging the scan-lines of the decorative images before transmittance to the inkjet print head unit from the web-fed inkjet print system. A scan-line is one line, or row of the decorative image. Such merging may be performed by a CPU such as, an Intel Xeon w3550 which has 4 cores at 3.06 GHz but a Graphic Processing Unit is more preferred. The advantage of such merging is that the first and second time period in the present invention is more easily to overlap. It is always possible that the number of copies in a print job, assigned to the first print zone is different than the number of copies in a print job assigned to the second print zone. Also the start time between the two print jobs may be different.

The deco workflow system preferable comprises:
color management software to split a decorative image to the colors of the inkjet ink set from the web-fed inkjet print system; and/or
input controller: to make the decorative images readable by the inkjet printheads in the web-fed inkjet print system and also splits the decorative image depending on the print mode (such two pass); and/or
print manager: software that communicates with the entire web-fed inkjet print system and also triggers the image data flow to the inkjet print heads: and/or
printheads controller: to control the inkjet printheads and ensures that the data are timely sent to each and every nozzle. The data transfer may be send at the print speeds, for example in single pass inkjet printing, between 1000 to 20000 Hz.

The deco workflow system may also have software programs including data base to administrate data records or print jobs, customized MRP-interface or user interface to connected machine control, a camera system for customized tasks in the manufacturing rooms.

Print producers or brand owners can submit print jobs for their decorative layers and decorative panels to a submission portal, preferably through a web store. The web store specifically designed for manufacturing decorative panels is in the present invention called a deco storefront.

Submitting a print job involves providing preferably at least information regarding:
the web-fed inkjet print system on which the print job is to be printed;
the web substrate on which the print job is to be printed;
the quality level with which the print job is to be printed;
the number of items that are to be printed, also called the number of copies;
a content file describing the decorative image(s) that are to be printed.

All the submitted data together define a print job. Multiple print jobs together define a print job list.

The submission portal preferably comprises a first pre-flight engine. The action of such a pre-flight engine is to check if all the constraints are met to print a print job on the web-fed inkjet print system and selected web substrate media, and to generate warnings or apply fixes in the case of non-conformity.

For the purpose of productivity, a print producer or a brand owner can make use of a product template in which some of the information is preset, while a number of variables and data can be edited.

The submission portal has a back end that preferably enables a submission portal operator to perform the following operations:
get an overview of the submitted print jobs in a job list (105);
manage the submitted jobs: previewing them, re-editing them, approving them, changing their order, deleting them etc.;
manage and design a product template;
do a number of administrative tasks such as the creation or the deletion of web stores, of print producer accounts, of manager accounts, etc.

A submission portal operator can be a print producer or the brand owner.

These submission portal operators only get to see jobs created in the deco web stores that are associated with them. Alternatively, a submission portal operator can be a super user who has privileges to have access to all the jobs that have been submitted to the portal by the different front end users.

For the print job, the JDF framework from CIP4™ organization may be chosen. A JDF job ticket is an open, extensible, XML-based specification of the complete workflow including all the production steps to create a printed product (www.cip4.org). The JDF job ticket in the current invention comprises the information regarding the production data part of the product specification, as well as administrative data regarding the web store and the print producer.

In a JDF job ticket, there is a provision for including proprietary XML formatted data. In the current invention this feature may be used to embed a “job XML file”. Such a job XML file provides a vehicle to support proprietary instructions for driving a proprietary output device. By embedding a job XML file in the JDF ticket, it is possible to store at the level of the submission portal data that otherwise would not fit or belong in the JDF job ticket.

The JDF job ticket and the content file are optionally bundled in an ASCII encoded container file such as in a MIME file.

The print job preferably also contains the type of heat press, more preferably contains the type of heat press and/or specific configurations of the heat press (such as temperature, pressure. . . ) so the correct heat press is correctly assigned for the decorative layer and also the correct printing zone of the present invention is supplied with the correct print job. Other information in such print jobs may also be provided namely how the decorative panel have to be cut, which type of mechanical joint have to be milled, which other layers have to be supplied. . . All these information is sometimes also called meta-data. The meta-data may also be embedded in the decorative image.

The more meta-data is in the print job, how easier it is to automate the whole manufacturing process of decorative panels. The meta-data may disclose several settings: from color management settings, halftone settings to print mode settings, to heat press settings, to cut settings. The print job can be followed, also called tracked, in the whole process of manufacturing decorative panels. The post processing of decorative layers comprising the inkjet printed decorative image, such as heat pressing the decorative layers with other layers to decorative panels, applying a relief structure on the decorative panels if not done in the step of heat pressing, cutting the decorative panels in to decorative laminates, milling a mechanical joint on the decorative laminates, such as tongue and groove . . . may be done remotely for economic and ecologic reasons to bring the post processing of these decorative layers closer to the consumer and thus to minimize the transport distance and to minimize the emissions from the transporter of the end product bought by the consumer. Therefor is a tracking mechanism with such print jobs an asset.

Another advantage is that the assignment of a heat press, whether or not by analysing the print job, a correct color conversion may be achieved. It is found that a type of heat press and specific configuration of a heat press, such as certain temperature-setting, may influence the colors in the decorative layer when heat-setted to a decorative panel. The deco workflow system may provide a color management system which taken into account the assignment of the heat press.

The type of heat press and/or specific configurations of the heat press may be determined by analysing the print job. For example the print job may also contains the particulars of sender, such as a brand owner or print producer, whereby the deco workflow system analyses which type of heat press should be used according known wishes of the sender. The deco workflow system adds after the analysing the type of heat press and/or specific configuration of the heat press. Another example is that the content of to be printed decorative image is analysed whereby the deco workflow system determines the type of heat press and/or specific configuration of the heat press. The deco workflow system adds after the analysing the type of heat press and/or specific configuration of the heat press. An example of analysis, such as image analysis, on the decorative images may comprise the total coverage of the decorative image. Darker decorative image need normally a higher pressure while heat pressing the decorative layer comprising such decorative images. The analysis, such as image analysis, may be done in the pre-flight engine.

An overview of image analysis methods that may be performed by the deco workflow system is disclosed in Part 5 “Image Analysis” [Page 419-678] of PRATT, William K. Digital Image Processing: PIKS Scientific Inside. 4th edition. John Wiley.

Preferably an image analysis method, comprised in the analysis of the decorative image methods comprises:
edge detection; and/or
image segmentation; and/or
shape analysis; and/or
texture analysis.

Other examples of analysis on decorative images/print jobs:
dimension determination whereby the correct heat press type capable of heat pressing such dimension is assigned.
determining the delivery address for the decorative panel(s), which is then also disclosed in the print job. Depending the delivery address the nearest heat press is allocated to the print job, so the production time becomes smaller and the transport cost is lower. The delivery address, more general an identification of the location for heat pressing is contained in the print job are later added after analysis the delivery address. The identification of the location may be determined from a database connected to the deco workflow system comprising the locations of several heat presses.

Configuration settings, determined from the analysis or added in the print job may be marked on the decorative layer by text, or more preferably an identification code, such a barcode or QR code. An identification code reader, connected to the heat press may read this identification code and a controller may configure the heat press according the content of the identification code. The identification code is preferably applied by the web-fed inkjet print system of the present invention and more preferably by an inkjet printhead comprised in the inkjet printhead unit (500), thus with one of the inks of the ink set in the web-fed inkjet print system.

The print job preferably also contains the type of resin impregnator, more preferably contains the type of resin impregnator and/or specific configurations of the resin impregnator (such as temperature, type of resin, pressure. . . ) so the correct resin impregnator is correctly assigned for the decorative layer and also the correct printing zone of the present invention is supplied with the correct print job. Other information in such print jobs may also be provided namely how the decorative panel have to be cut, which type of mechanical joint have to be milled, which other layers have to be supplied. . . . All these information is sometimes also called meta-data. The meta-data may also be embedded in the decorative image.

The more meta-data is in the print job, how easier it is to automate the whole manufacturing process of decorative panels. The meta-data may disclose several settings: from color management settings, halftone settings to print mode settings, to resin impregnator settings, to cut settings. The print job can be followed, also called tracked, in the whole process of manufacturing decorative panels. The post processing of decorative layers comprising the inkjet printed decorative image, such as resin impregnating the decorative layers with other layers to decorative panels, applying a relief structure on the decorative panels if not done in the step of resin impregnating, cutting the decorative panels in to decorative laminates, milling a mechanical joint on the decorative laminates, such as tongue and groove. . . may be done remotely for economic and ecologic reasons to bring the post processing of these decorative layers closer to the consumer and thus to minimize the transport distance and to minimize the emissions from the transporter of the end product bought by the consumer. Therefor is a tracking mechanism with such print jobs an asset.

Another advantage is that the assignment of a resin impregnator, whether or not by analysing the print job, a correct color conversion may be achieved. It is found that a type of resin impregnator and specific configuration of a resin impregnator, such as certain temperature-setting, may influence the colors in the decorative layer when heat-setted to a decorative panel. The deco workflow system may provide a color management system which taken into account the assignment of the resin impregnator.

The type of resin impregnator and/or specific configurations of the resin impregnator may be determined by analysing the print job. For example the print job may also contains the particulars of sender, such as a brand owner or print producer, whereby the deco workflow system analyses which type of resin impregnator should be used according known wishes of the sender or according to predefined user needs. The deco workflow system adds after the analysing the type of resin impregnator and/or specific configuration of the resin impregnator and/or type of resin. Another example is that the content of to be printed decorative image is analysed whereby the deco workflow system determines the type of resin impregnator and/or specific configuration of the resin impregnator and/or type of resin. The deco workflow system adds after the analysing the type of resin impregnator and/or specific configuration of the resin impregnator and/or type of rsin. An example of analysis, such as image analysis, on the decorative images may comprise the total coverage of the decorative image. Darker decorative image need normally a thicker layer of resin while resin impregnating the decorative layer comprising such decorative images. The analysis, such as image-analysis, may be done in the pre-flight engine.

An overview of image analysis methods that may be performed by the deco workflow system is disclosed in Part 5 “Image Analysis” [Page 419-678] of PRATT, William K. . . Digital Image Processing: PIKS Scientific Inside. 4th edition. John Wiley.

Preferably an image analysis method, comprised in the analysis of the decorative image methods comprises:
edge detection; and/or
image segmentation; and/or
shape analysis; and/or
texture analysis.

Other examples of analysis on decorative images/print jobs:
dimension determination whereby the correct resin impregnator type capable of resin impregnating such dimension is assigned.
determining the delivery address for the decorative panel(s), which is then also disclosed in the print job. Depending the delivery address the nearest resin impregnator is allocated to the print job, so the production time becomes smaller and the transport cost is lower. The delivery address, more general an identification of the location for resin impregnating is contained in the print job are later added after analysis the delivery address. The identification of the location may be determined from a database connected to the deco workflow system comprising the locations of several resin impregnators.

Configuration settings, determined from the analysis or added in the print job may be marked on the decorative layer by text, or more preferably an identification code, such a barcode or QR code. An identification code reader, connected to the resin impregnator may read this identification code and a controller may configure the resin impregnator according the content of the identification code. The identification code is preferably applied by the web-fed inkjet print system of the present invention and more preferably by an inkjet printhead comprised in the inkjet printhead unit (500), thus with one of the inks of the ink set in the web-fed inkjet print system.

### Deco Storefront

In a preferred embodiment, a cloud-based web-to-render solution may be comprised in the deco workflow system to enable decorative panel service providers or decorative panel buyers to create and manage online stores for manufacturing of decorative panels comprising a rendered decorative image. Such solution is called a deco storefront.

Preferably, a deco storefront is marketed as a hosted cloud service so there is no high initial investment needed in servers, software, databases or expensive symmetrical internet connections. This reduces the cost of deploying stores and improves their time-to-market.

The deco storefront may have an easy manageable store centre, which is the central hub from which stores are set up and orders are tracked. Its dashboard preferably provides instant feedback about incoming orders and the status of orders that are in progress.

The deco storefront preferably comprises an online editor wherein decorative panel service providers or editors may design or edit decorative images. This gives the ability to the decorative panel service providers an innovative way of creating personalized decorative panels.

The integration of the deco storefront in a deco workflow system may increase the efficiency by saving time in for example the automatically downloading and processing orders of decorative panels comprising rendered decorative images.

### Graphic Processing Units

Preferably the rendering step in the deco workflow system is performed by one or more Graphic Processing Units (GPU's). They have been used to render computer graphics for years. Nowadays they are also used for general-purpose tasks due to their highly parallel structure, making them more efficient than Central Processing Units (CPU's). GPU's in the present invention are an advantage in the present invention namely for rendering the decorative image but also for the image analysis of the decorative image and the image analyses of captured images from the optical scanning system.GPU's can be combined with CPU's to achieve greater performance. In this way, serial parts of the code would run on the CPU and parallel parts would do it on the GPU. While CPU's with multiple cores are available for every new computer and allow the use of parallel computing, these are focused on having a few high performance cores. On the other hand, GPU's have an architecture consisting of thousands of lower performance cores, making them especially useful when large amount of data have to be processed.

1-15. (canceled)

16. A method of manufacturing decorative panels including the steps of:
inkjet printing with a web-fed inkjet print system on a first web substrate for forming a first decorative layer (301) in a first time period;
inkjet printing with the web-fed inkjet print system on the first web substrate or a second web substrate for forming a second decorative layer (302) in a second time period;
heat pressing the first decorative layer (301) into a decorative panel (331) on a first heat press (401); and
heat pressing the second decorative layer (302) into a second decorative panel (332) on a second heat press (402); wherein the first and second time period overlap.

17. The manufacturing method according to claim 16, wherein the first web substrate and the second web substrate are paper substrates, which both have on their surface one or more ink-receiving layers for receiving aqueous pigmented inkjet inks.

18. The manufacturing method according to claim 17, wherein an outermost ink-receiving layer contains no inorganic pigment or contains a smaller content of inorganic pigment than an ink-receiving layer between one or both of the paper substrates and the outermost ink-receiving layer.

19. The manufacturing method according to claim 17, wherein one or both of the paper substrates or first decorative layer or second decorative layer is impregnated by a thermosetting resin before heat pressing.

20. The manufacturing method according to claim 19, wherein the thermosetting resin is selected from the group consisting of melamine-formaldehyde based resins, urea-formaldehyde based resins and phenol-formaldehyde based resins.

21. The manufacturing method according to claim 17, wherein the aqueous pigmented inkjet inks include a red inkjet ink containing a pigment selected from the group consisting of C.I. Pigment Red 254, C.I. Pigment Red 176, C.I. Pigment Red 122, and mixed crystals thereof.

22. The manufacturing method according to claim 17, wherein the first decorative layer (301) is heat pressed into the decorative panel together with a core layer (321, 322) and a protective layer; and wherein the core layer (321, 322) is selected from the group consisting of MDF, HDF and OSB.

23. The manufacturing method according to claim 16, wherein the web-fed inkjet print system is a web-fed multi pass inkjet print system.

24. The manufacturing method according to claim 16, wherein the decorative panel is a vinyl tile, and wherein the first web substrate and the second web substrate is a thermoplastic substrate and the web-fed inkjet print system inkjet prints UV curable pigmented inkjet inks on the thermoplastic substrate.

25. The manufacturing method according to claim 24, wherein the thermoplastic substrate comprises a material selected from the group consisting of polyvinylchloride (PVC), polypropylene (PP), polyethylene (PE), polyethylene-terephthalate (PET),thermoplastic polyurethane (TPU) and combinations thereof.

26. The manufacturing method according to claim 25, wherein the UV curable pigmented inkjet inks include a red inkjet ink containing a pigment selected from the group consisting of C.I. Pigment Red 254, C.I. Pigment Red 176 and C.I. Pigment Red 122 or mixed crystals thereof.

27. The manufacturing method according to claim 26, wherein the web-fed inkjet print system is a web-fed multi pass inkjet print system.
